(19) United States
(12) Patent Application Publication
(10) Pub. No.: US 2013/0182763 A1
(43) Pub. Date: Jul. 18, 2013

(54) VIDEO ENCODING APPARATUS, DECODING APPARATUS AND VIDEO ENCODING METHOD

(71) Applicants: Goki YASUDA, Kawasaki-shi (JP); Takeshi CHUJOH, Kawasaki-shi (JP)

(72) Inventors: Goki YASUDA, Kawasaki-shi (JP); Takeshi CHUJOH, Kawasaki-shi (JP)

(21) Appl. No.: 13/548,284

(22) Filed: Jul. 13, 2012

Related U.S. Application Data
(63) Continuation of application No. PCT/JP2010/071144, filed on Nov. 26, 2010.

(30) Foreign Application Priority Data
Jan. 13, 2010 (JP) PCT/JP2010/050283

(51) Int. Cl. H04N 7/26

(52) U.S. Cl. CPC H04N 19/00896; H04N 19/00587
USPC 375/240.12

(57) ABSTRACT

According to one embodiment, a video encoding apparatus includes a controller, a loop filter processor, a interpolation filter, a generator, a transform unit, a quantizer, an encoder. The interpolation filter processor directly calculates, if motion compensation prediction of quarter pixel precision is performed, a sub-pixel value of a sub-pixel displaced from an integer-pixel by a quarter pixel in a horizontal direction or a vertical direction based on integer-pixel values of a reproduction image signal, and to generate a reference image including a integer-pixel and a sub-pixel.

### CROSS REFERENCE TO RELATED APPLICATIONS

This application is a Continuation application of PCT Application No. PCT/JP2010/071144, filed Nov. 26, 2010 and based upon and claiming the benefit of priority from prior International Patent Application No. PCT/JP2010/050283, filed Jan. 13, 2010, the entire contents of all of which are incorporated herein by reference.

### FIELD

Embodiments described herein relate generally to a video encoding apparatus, a decoding apparatus and a video encoding method.

### BACKGROUND

Techniques of interpolation filter for generating a reference image used for motion compensation of sub-pixel precision are widely used as video encoding techniques, and are also used in H.264/MPEG-4AVC (hereinafter referred to as H.264), i.e., one of international standard specifications of video encoding. In the H.264 interpolation filter, first, a half pixel is calculated, and a pixel displaced in the horizontal direction by a quarter pixel and a pixel displaced in the vertical direction by a quarter pixel are calculated from an average of the calculated half pixel and an integer-pixel. For this reason, high frequency component may be greatly reduced. There is a technique called Adaptive Interpolation Filter (AIF) for improving the efficiency of motion compensation by adaptively changing the interpolation filter (see, e.g., Y. Vatis, B. Edler, D. T. Nguyen, J. Ostermann, “Two-dimensional non-separable Adaptive Wiener Interpolation Filter for H.264/AVC”, ITU-T SGI 6/Q.6 VCEG-Z17, Busan, South Korea, April 2005). In the AIF, an encoding side sets and transmits information including coefficients of an interpolation filter, and a decoding side applies the interpolation filter by using the received information.

Another technique for improving the prediction efficiency with the motion compensation includes Adaptive Loop Filter (ALF) which is a loop filter for improving image quality by causing an encoding side to set and transmit filter information including filter coefficients and causing a decoding side to use the filter information (see, e.g., T. Chujoh, N. Wada, G. Yasuda, “Quadtree-based Adaptive Loop Filter,” ITU-T Q.6/SG16 Doc., C181, Geneva, January 2009).

### BRIEF DESCRIPTION OF THE DRAWINGS

FIG. 1 is a block diagram illustrating a video decoding apparatus according to the first embodiment.

FIG. 2 is a figure illustrating an example of filter processing of an interpolation filter processor according to the first embodiment.

FIG. 3 is a flowchart illustrating operation of filter processing of the interpolation filter processor.

FIG. 4 is a figure illustrating an example of filter processing of a loop filter processor according to the first embodiment.

FIG. 5 is a block diagram illustrating a video decoding apparatus according to the second embodiment.

FIG. 6 is a block diagram illustrating a loop filter processor according to the third embodiment.

FIG. 7 is a flowchart illustrating operation of the loop filter processor according to the third embodiment.

FIG. 8 is a figure illustrating an example of a filter included in a filter unit.

FIG. 9 is a figure illustrating a first modification of a filter included in the filter unit.

FIG. 10 is a figure illustrating a second modification of the filter.

FIG. 11 is a figure illustrating a third modification of the filter.

FIG. 12 is a figure illustrating a fourth modification of the filter.

FIG. 13 is a figure illustrating an example of a syntax structure.

FIG. 14 is a figure illustrating an example of a syntax structure of a loop filter data syntax.

FIG. 15 is a figure illustrating an example of a loop filter data syntax.

FIG. 16 is a figure illustrating an example of filter processing of an interpolation filter processor according to the fifth and sixth embodiments.

### DETAILED DESCRIPTION

When H.264 interpolation filter and ALF are used at the same time, ALF is basically a Low Pass Filter (LPF), and therefore, this means that interpolation filter for greatly reducing high-frequency component is applied to a reference image to which ALF has been applied, and there is a problem in that the high-frequency component of the interpolated reference image is excessively reduced.

When AIF and ALF are used at the same time, the prediction efficiency improves, but because two kinds of adaptive filters are used together, there is a problem in that the amount of codes in the filter coefficients increases, and further, because AIF requires an interpolation filter to be constituted by a multiplier, there is a problem in that the circuit size of the (Large-Scale Integration) LSI increases.

In general, according to one embodiment, a video encoding apparatus includes a controller, a loop filter processor, a interpolation filter, a generator, a transform unit, a quantizer, an encoder. The controller is configured to generate a loop filter information item indicating information for performing filter processing on a local decoded image signal. The loop filter processor is configured to perform the filter processing on the local decoded image signal based on the loop filter information item to generate a reproduction image signal. The interpolation filter processor configured, if motion compensation prediction of quarter pixel precision is performed, to directly calculate a sub-pixel value of a sub-pixel displaced from an integer-pixel by a quarter pixel in one of a horizontal direction and a vertical direction, based on integer-pixel values of the reproduction image signal, and to generate a reference image including a integer-pixel and a sub-pixel. The generator is configured to generate a prediction image signal representing a prediction image by performing motion compensation prediction on the reference image. The transform unit is configured to transform a residual signal to obtain a transform coefficient information item, the residual signal indicating a difference between the prediction image signal and an input image signal which is an image signal that has been input, the transform coefficient information item indicating a frequency component value of the pixel. The quantizer is configured to quantize the transform coefficient information item to obtain quantized transform coefficient information item. The encoder configured to encode the quantized transform coefficient information item and the loop filter information item.

A video encoding apparatus, a decoding apparatus and a video encoding method according to the present embodiment will be hereinafter explained in detail with reference to drawings. It should be noted that in the embodiments below, portions denoted with the same reference numerals are assumed to perform the same operations, and repeated explanation thereabout is omitted.

### First Embodiment

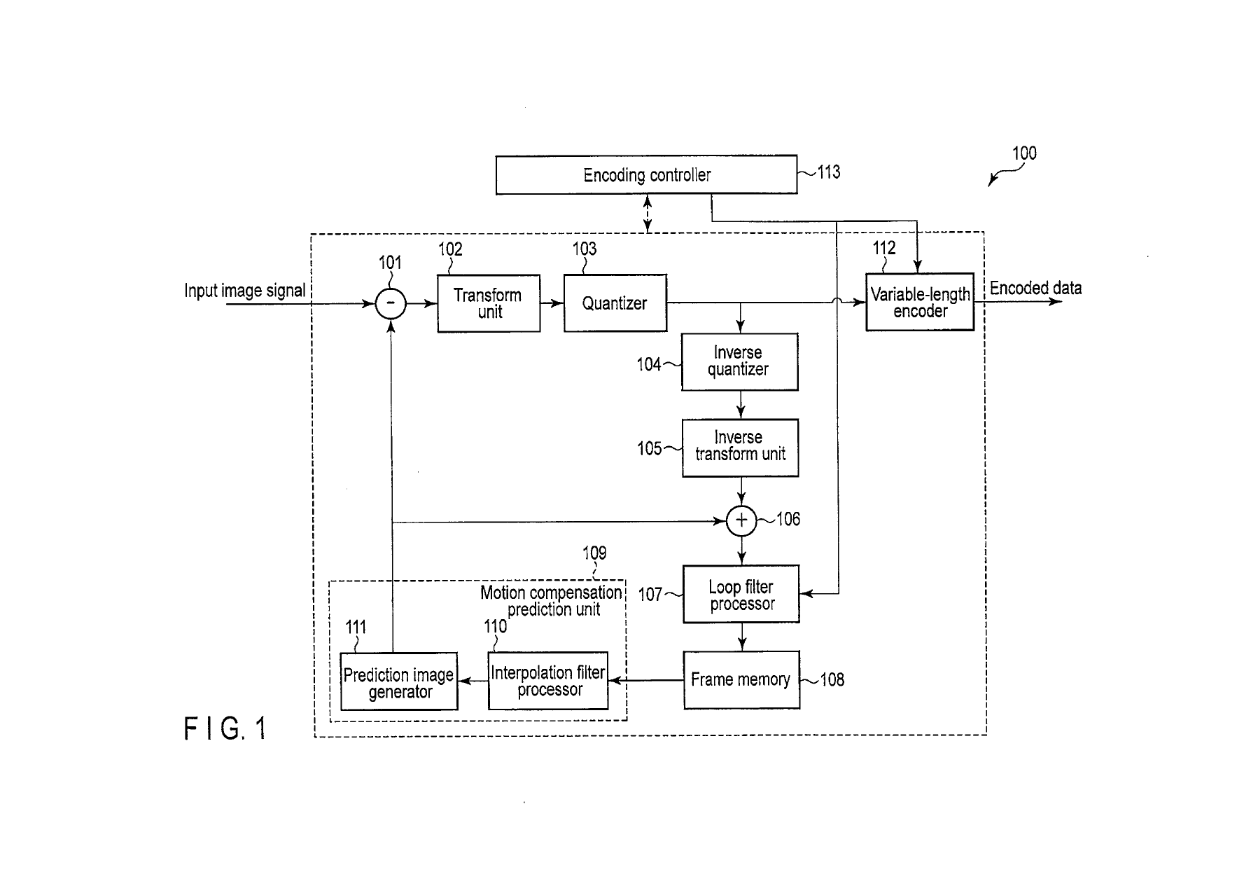

The video encoding apparatus according to the first embodiment will be explained in detail with reference to FIG. 1.

The video encoding apparatus 100 according to the first embodiment includes a subtractor 101, a transform unit 102, a quantizer 103, an inverse quantizer 104, an inverse transform unit 105, an adder 106, a loop filter processor 107, a frame memory 108, an interpolation filter processor 110, a prediction image generator 111, a variable-length encoder 112, and an encoding controller 113. The interpolation filter processor 110 and the prediction image generator 111 may be collectively referred to as a motion compensation prediction unit 109.

The subtractor 101 receives an input image signal from the outside and receives a prediction image signal from the prediction image generator 111 explained later, and outputs, as a residual signal, a difference between the input image signal and the prediction image signal.

The transform unit 102 receives the residual signal from the subtractor 101, transforms the residual signal, and generates transform coefficient information item indicating a frequency component value. The quantizer 103 receives transform coefficient information item from the transform unit 102, quantizes the transform coefficient information item, and obtains quantized transform coefficient information item.

The inverse quantizer 104 receives the quantized transform coefficient information item from the quantizer 103, inverse quantizes the quantized transform coefficient information item, and generates reproduction transform coefficient information item indicating reproduced transform coefficient information item.

The inverse transform unit 105 receives the reproduction transform coefficient information item from the inverse quantizer 104, inverse transforms the reproduction transform coefficient information item, and generates a reproduction residual signal indicating a reproduced residual signal.

The adder 106 receives the reproduction residual signal from the inverse transform unit 105 and receives the prediction image signal from the prediction image generator 111 explained later. Then, the adder 106 adds the reproduction residual signal and the prediction image signal, and generates a local decoded image signal. The local decoded image signal is an image signal obtained by decoding a pixel value of a pixel within a processing block unit.

The loop filter processor 107 receives the local decoded image signal from the adder 106 and receives the loop filter information item from the encoding controller 113 explained later, and performs filter processing on the local decoded image signal based on the loop filter information item, thereby generating a reproduction image signal. The loop filter information item is information for controlling the filter processing, and includes filter coefficient information item. For example, the loop filter information item is generated in units of slices. The filter coefficient information item is information indicating filter coefficients used for integer-pixels in the filter processing. The filter coefficient information item is calculated in advance by designing Wiener filter generally used in image decoding from the local decoded image and the input image in the encoding controller 113.

The frame memory 108 receives the reproduction image signal from the loop filter processor 107, and accumulates the reproduction image signal.

The interpolation filter processor 110 reads the reproduction image signal from the frame memory 108, performs filter processing on the reproduction image signal, and generates a reference image of sub-pixel precision. The integer-pixel and the sub-pixel explained below mean not only the position of the pixel but also the pixel value of the pixel.

The prediction image generator 111 receives the reference image from the interpolation filter processor 110, uses the reference image to perform motion compensation prediction of sub-pixel precision, and generates a prediction image signal.

The variable-length encoder 112 receives the quantized transform coefficient information item from the quantizer 103, and receives the loop filter information item from the encoding controller 113 explained later. Then, the variable-length encoder 112 encodes the quantized transform coefficient information item and the loop filter information item, and generates encoded data item.

For example, the encoding controller 113 generates a motion vector used for motion compensation prediction, and determines a prediction mode. In particular, the encoding controller 113 designs the filter used in the loop filter processor 107 to generate the loop filter information item.

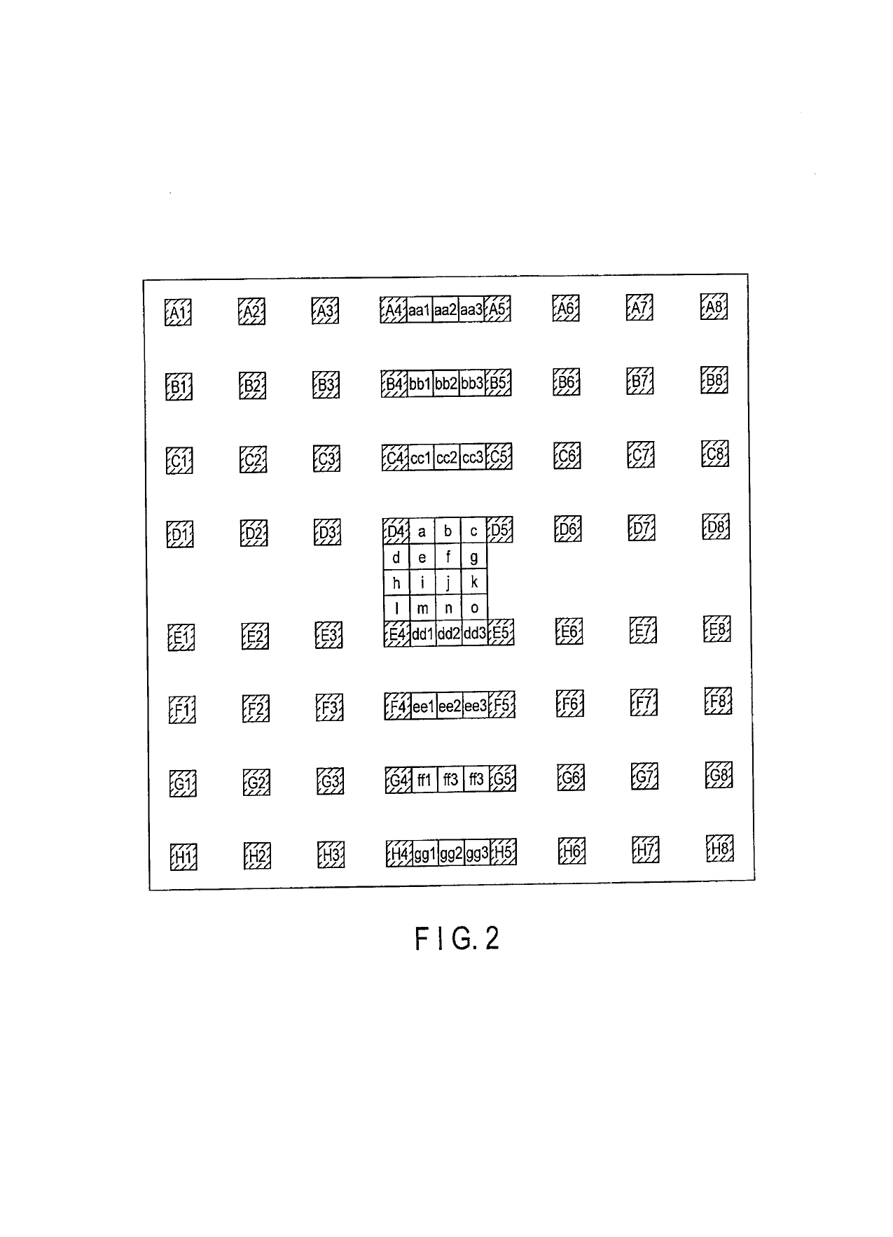

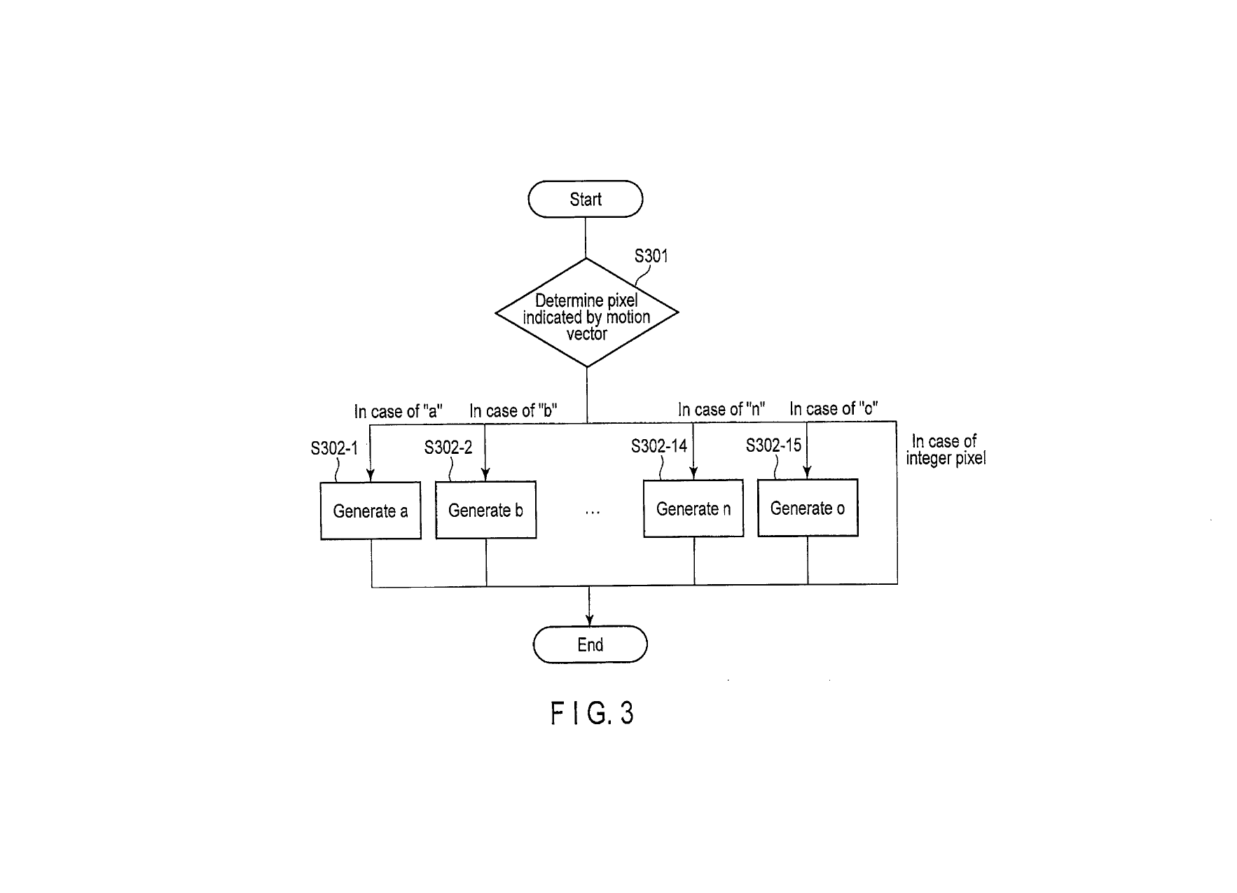

Subsequently, an example of filter processing of the interpolation filter processor 110 will be explained in detail with reference to FIGS. 2 and 3.

FIG. 2 shows a region of an image accumulated in the frame memory 108. In FIG. 2, A1 to A8, B1 to B8, C1 to C8, D1 to D8, E1 to E8, F1 to F8, G1 to G8, and H1 to H8 denote integer-pixels. On the other hand, “a” to “o”, aa1 to aa3, bb1 to bb3, cc1 to cc3, dd1 to dd3, ee1 to ee3, ff1 to ff3, gg1 to gg3 denote sub-pixels.

FIG. 3 is a flowchart illustrating operation of the interpolation filter processor 110.

In step S301, the interpolation filter processor 110 determines a pixel indicated by a motion vector used in the motion compensation prediction. Then, when the determined motion vector indicates a sub-pixel, a corresponding step in step S302-1 to step S302-15 is performed. For example, when the pixel indicated by the motion vector is a sub-pixel “a”, step S302-1 is performed. When the pixel indicated by the motion vector is a sub-pixel “n”, step S302-14 is performed. When the pixel indicated by the motion vector is an integer-pixel, the processing is terminated.

In step S302, the sub-pixels “a” to “o” are respectively generated in each of step S302-1 to step S302-15.

Now, the method for generating the sub-pixels “a” to “o” in step S302 will be explained in more detail.

First, the method for generating the sub-pixels “a”, “c”, “d” and “l” will be explained. In the example of FIG. 2, the interpolation filter processor 110 directly calculates, from the integer-pixels in the same row in the horizontal direction, the sub-pixel “a” displaced to the right by the quarter pixel in the horizontal direction with respect to the integer-pixel D4 and the sub-pixel “c” displaced to the left by the quarter pixel in the horizontal direction with respect to the integer-pixel D5. In other words, in FIG. 2, only the integer-pixels D1 to D8, which are in the same row as the integer-pixels D4 and D5 in the horizontal direction, are used to calculate the sub-pixels “a” and “c”. When the sub-pixels “a” and “c” are calculated, the sub-pixel “b” is not used.

Likewise, the interpolation filter processor 110 directly calculates, from the integer-pixels in the same row in the vertical direction, the sub-pixel “d” displaced to the lower side by the quarter pixel in the vertical direction with respect to the integer-pixel D4 and the sub-pixel “l” displaced to the upper side by the quarter pixel in the vertical direction with respect to the integer-pixel E4. In other words, in FIG. 2, the sub-pixels “d” and “l” are calculated using the integer-pixels A4, B4, C4, D4, E4, F4, G4, and H4 in the same row as D4 and E4 in the vertical direction. The sub-pixel “h” is not used to calculated the sub-pixels “d” and “l”.

More specifically, the sub-pixels “a”, “c”, “d” and “l” are calculated using, expression (1-1) and expression (1-2), expression (2-1) and expression (2-2), expression (3-1) and expression (3-2), expression (4-1) and expression (4-2), respectively.

a=(a′+r_ofst)>>num_shift (1-1)

c=(c′+r_ofst)>>num_shift (2-1)

d=(d′+r_ofst)>>num_shift (3-1)

l=(l′+r_ofst)>>num_shift (4-1)

a′=h₁^{a}D1+h₂^{a}D2+h₃^{a}D3+h₄^{a}D4+h₅^{a}D5+h₆^{a}D6+h₇^{a}D7+h₈^{a}D8 (1-2)

c′=h₁^{c}D1+h₂^{c}D2+h₃^{c}D3+h₄^{c}D4+h₅^{c}D5+h₆^{c}D6+h₇^{c}D7+h₈^{c}D8 (2-2)

d′=h₁^{d}A4+h₂^{d}B4+h₃^{d}C4+h₄^{d}D4+h₅^{d}E4+h₆^{d}F4+h₇^{d}G4+h₈^{d}H4 (3-2)

l′=h₁^{l}A4+h₂^{l}B4+h₃^{l}C4+h₄^{l}D4+h₅^{l}E4+h₆^{l}F4+h₇^{l}G4+h₈^{l}H4 (4-2)

In this case, the coefficients of the respective integer-pixels as shown in expression (5) in expression (1-2), expression (2-2), expression (3-2), and expression (4-2) denote an interpolation filter coefficient for calculating the sub-pixels “a”, “c”, “d” and “l”, respectively.

$${\{ {h}_{i}^{a} \}}_{i = 1}^{8} , {\{ {h}_{i}^{c} \}}_{i = 1}^{8} , {\{ {h}_{i}^{d} \}}_{i = 1}^{8} , {\{ {h}_{i}^{l} \}}_{i = 1}^{8} \qquad ( 5 )$$

It should be noted that num_shift denotes the number of bit shift of the pixel, and r_ofst denotes a value for adjusting round-off of the bits. For example, r_ofst is set at a value half of 2^{num}^{_{—}}^{shift}. “>>” is an operator representing bit shift operation. The value at the left-hand side of this operator is divided by bit-shifting the value to the right by num_shift bits. This is equivalent to operation of dividing the value at the left-hand side by 2^{num}^{shift} when the value at the left-hand side is represented in a decimal number.

More specifically, it is assumed that parameters as shown in expression (6-1) to expression (B) are given.

$$\begin{matrix}{\{ {h}_{i}^{a} \}}_{i = 1}^{8} = {\{ {h}_{i}^{d} \}}_{i = 1}^{8} = \{ - 3 , 12 , - 37 , 229 , 71 , - 21 , 6 , - 1 \} & ( 6 - 1 ) \\ {\{ {h}_{l}^{c} \}}_{i = 1}^{8} = {\{ {h}_{l}^{l} \}}_{i = 1}^{8} = \{ - 1 , 6 , - 21 , 71 , 229 , - 37 , 12 , - 3 \} & ( 6 - 2 ) \\ r\_ofst = 128 & ( 7 ) \\ num\_shift = 8 & ( 8 )\end{matrix}$$

In this case, in the interpolation filter processor 110, the sub-pixels “a”, “c”, “d” and “l” are calculated as shown in expression (9-1) and expression (9-2), expression (10-1) and expression (10-2), expression (11-1) and expression (11-2), and expression (12-1) and expression (12-2), respectively.

a=(a′+128)>>8 (9-1)

c=(c′+128)>>8 (10-1)

d=(d′+128)>>8 (11-1)

l=(l′+128)>>8 (12-1)

a′=−3D1+12D2−37D3+229D4+71D5−21D6+6D7−D8 (9-2)

c′=−D1+6D2−21D3+71D4+229D5−37D6+12D7−3D8 (10-2)

d′=−3A4+12B4−37C4+229D4+71E4−21F4+6G4−H4 (11-2)

l′=−A4+6B4−21C4+71D4+229E4−37F4+12G4−3H4 (12-2)

Subsequently, the method for generating the sub-pixels “b” and “h” will be explained. More specifically, the sub-pixel “b” is a half pixel of D4 and D5, and the sub-pixel “h” is a half pixel of D4 and E4. Therefore, sub-pixels “b” and “h” can be calculated using the same method as that applied to the above sub-pixels “a”, “c”, “d” and “l”. Calculation results of the sub-pixels “b” and “h” are shown in expression (13-1), expression (13-2), expression (14-1) and expression (14-2).

b=b′+128)>>8 (13-1)

h=h′+128)>>8 (14-1)

b′=−3D1+12D2−39D3+158D4+158D5−39D6+12D7−3D8 (13-2)

h′=−3A4+12B4−39C4+158D4+158E4−39F4+12G4−3H4 (14-2)

Subsequently, the method for generating the sub-pixels “e”, “i”, “m”, “f”, “j”, “n”, “g”, “k” and “o” will be explained.

Before the sub-pixels “e”, “i” and “m” are calculated, aa1′, bb1′, cc1′, dd1′, ee1′, ff1′, gg1′ are calculated in advance like expression (9-2) for sub-pixels aa1, bb1, cc1, dd1, ee1, ff1, gg1. Then, the sub-pixels “e”, “i” and “m” may be calculated as shown in expression (15), expression (16), and expression (17).

e=(−3aa1′+12bb1′−37cc1′+229a′+71dd1′−21ee1′+6ff1′−gg1′+32768)>>16 (15)

i=(−3aa1′+12bb1′−39cc1′+158a′+158dd1′−39ee1′+12ff1′−3gg1′+32768)>>16 (16)

m=(−aa1′+6bb1′−21cc1′+71a′+229dd1′−37ee1′+12ff1′−3gg1′+32768)>>16 (17)

Likewise, the sub-pixels “f”, “j” and “n” may be calculated with expression (18), expression (19), expression (20) like step S301 and step S302 upon calculating aa2′, bb2′, cc2′, dd2′, ee2′, ff2′, gg2′ in advance like expression (13-2) for the sub-pixels aa2, bb2, cc2, dd2, ee2, ff2, gg2.

f=(−3aa2′+12bb2′−37cc2′+229b′+71dd2′−21ee1′+6ff2′−gg2′+32768)>>16 (18)

j=(−3aa2′+12bb2′−39cc2′+158b′+158dd2′−39ee2′+12ff2′−3gg2′+32768)>>16 (19)

m=(−aa2′+6bb2′−21cc2′+71b′+229dd2′−37ee2′+12ff2′−3gg2′−32768)>>16 (20)

Likewise, the sub-pixels “g”, “k” and “o” may be calculated with expression (21), expression (22), expression (23) like step S301 and step S302 upon calculating aa3′, bb3′, cc3′, dd3′, ee3′, ff3′, gg3′ in advance like expression (10-2) for the sub-pixels aa3, bb3, cc3, dd3, ee3, ff3, gg3.

g=(−3aa3′+12bb3′−37cc3′+229c′+71dd3′−21ee3′+6ff3′−gg3′+32760)>>16 (21)

k=(−3aa3′+12bb3′−39cc3′+158c′+158dd3′−39ee3′+12ff3′−3gg3′+32768)>>16 (22)

o=aa3′+6bb3′−21cc3′+71c′+229dd3′−37ee3′+12ff3′+3gg3′+32768)>>16 (23)

By adapting step S301 and step S302 to each sub-pixel, the reference image of sub-pixel precision can be generated by calculating the sub-pixels within the block to be subjected to the interpolation filter processing.

In FIG. 2, the sub-pixels “e”, “i”, “m”, “f”, “j”, “n”, “g”, “k” and “o” are calculated using the sub-pixels in the vertical direction. Alternatively, the sub-pixels “e”, “i”, “m”, “f”, “n”, “g”, “k” and “o” may be calculated using the sub-pixels in the horizontal direction. For example, when the sub-pixels “e”, “f” and “g” are calculated, the sub-pixel in the same row in the horizontal direction (in FIG. 2, for example, the sub-pixel “d” which is displaced to the lower side in the vertical direction by the quarter pixel with respect to the integer-pixel D4) is calculated first, and the sub-pixel in the same row in the horizontal direction is used, so that the sub-pixels “e”, “f” and “g” can be calculated.

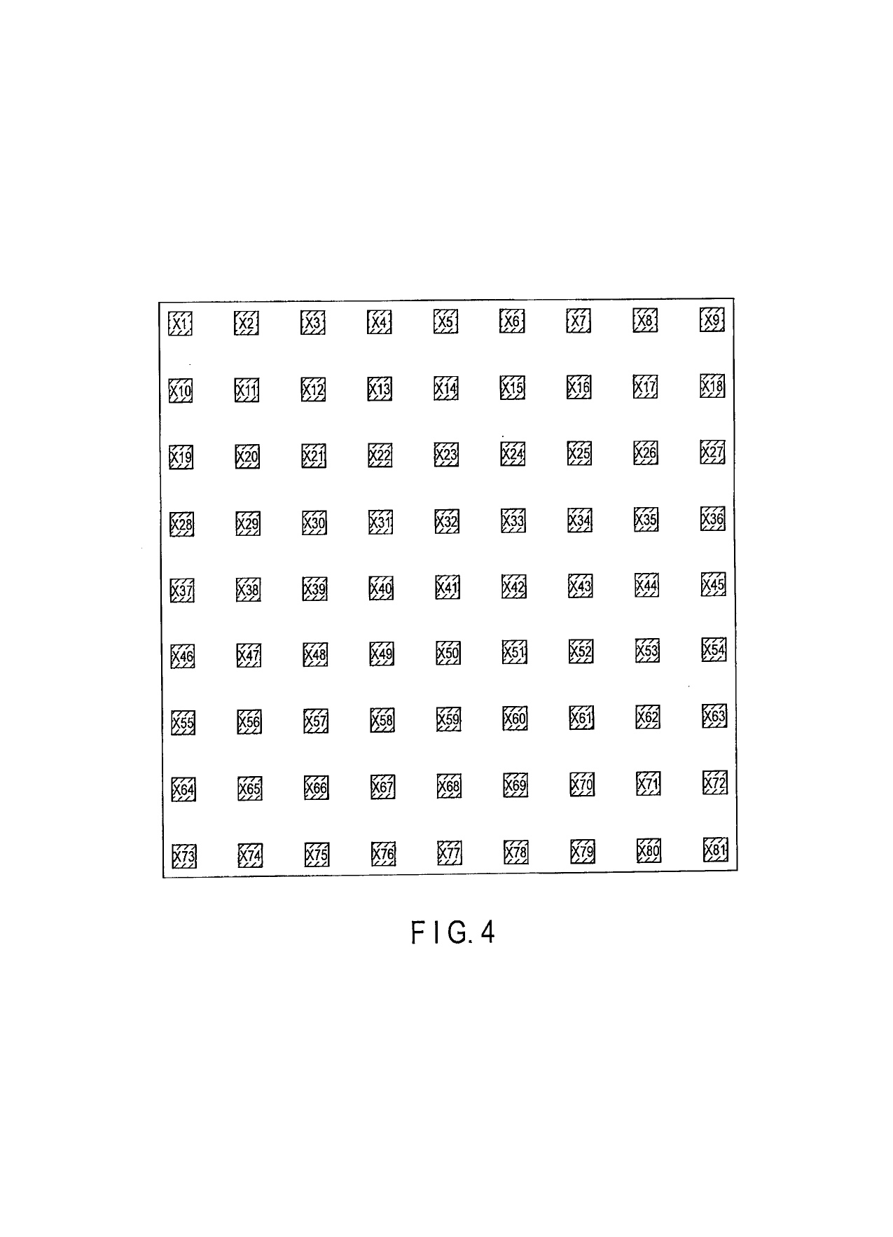

Subsequently, the filter processing in the loop filter processor 107 will be explained in detail with reference to FIG. 4. FIG. 4 shows a case where a two-dimensional filter represented as 9×9 tap is used, for example. “X1” to “X81” denote integer-pixels.

The loop filter processor 107 receives coefficient information item about the two-dimensional filter represented by 9×9 tap as shown in expression (24) as the loop filter information item from the encoding controller 113.

$${\{ {h}_{i} \}}_{i = 1}^{81} \qquad ( 24 )$$

In this case, when the integer-pixel X41 is subjected to the filter processing, the filter processing is performed using expression (25).

$${X}^{′} 41 = ( {\sum }_{i = 1}^{81} {h}_{i} Xi + 128 ) >> 8 \qquad ( 25 )$$

The loop filter processor 107 performs operation of expression (24) on each pixel of the local decoded image signal, thereby generating a reproduction image signal having been subjected to the filter processing.

According to the first embodiment as explained above, the sub-pixel displaced by the quarter pixel in any one of the horizontal direction and the vertical direction from the integer-pixel is directly calculated from the integer-pixels, and this can prevent the high-frequency component of the interpolated reference image from being excessively decreasing, and therefore, the prediction efficiency of the motion compensation prediction can be improved.

### Second Embodiment

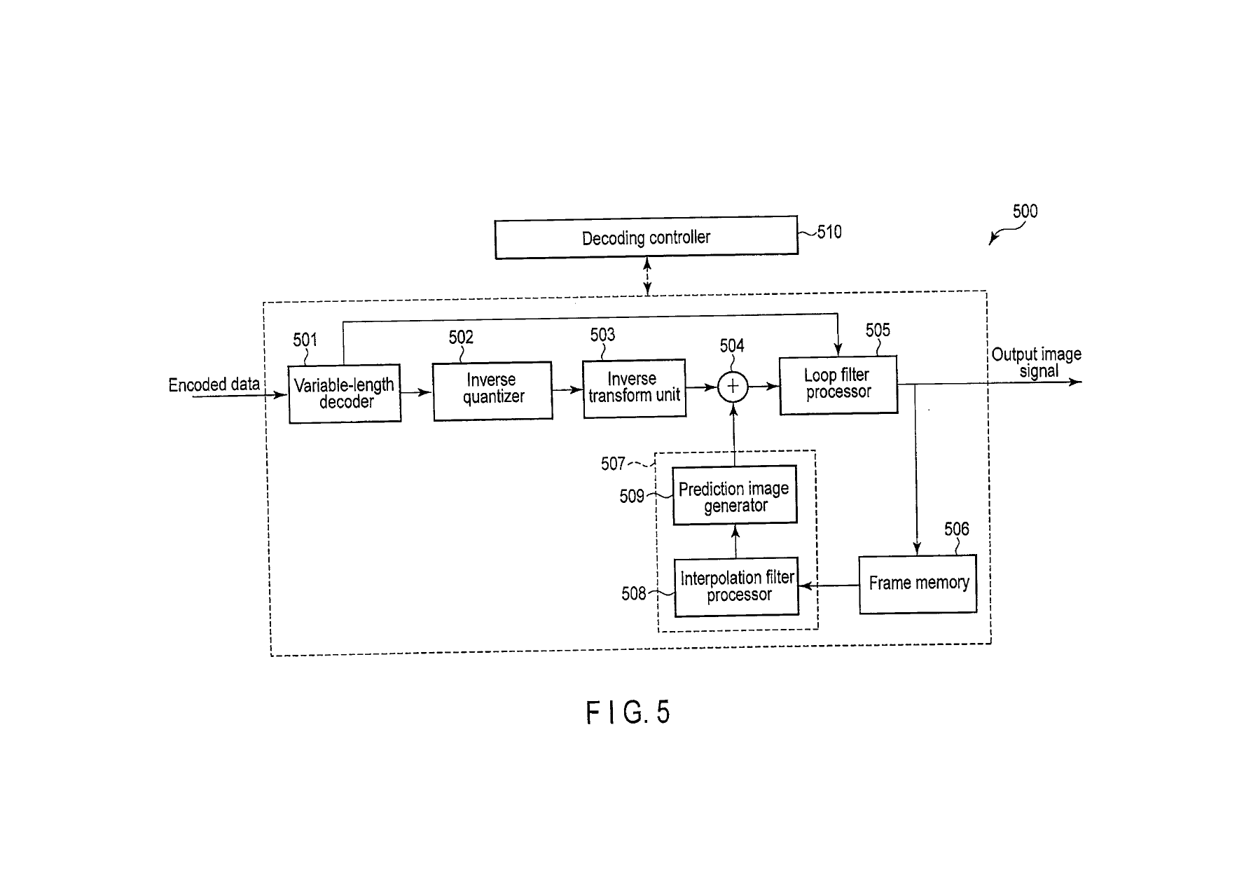

A video decoding apparatus according to the second embodiment will be explained in detail with reference to FIG. 5.

The video decoding apparatus 500 according to the second embodiment includes a variable-length decoder 501, an inverse quantizer 502, an inverse transform unit 503, an adder 504, a loop filter processor 505, a frame memory 506, an interpolation filter processor 508, a prediction image generator 509, and a decoding controller 510. The interpolation filter processor 508 and prediction image generator 509 may be collectively referred to a motion compensation prediction unit 507.

The variable-length decoder 501 receives encoded data generated by the video encoding apparatus 100 according to the first embodiment, decodes encoded quantized transform coefficient information item and encoded loop filter information item from the encoded data, and generates quantized transform coefficient information item and loop filter information item.

The inverse quantizer 502 receives the quantized transform coefficient information item from the variable-length decoder 501, inverse quantizes the quantized transform coefficient information item, and generates reproduction transform coefficient information item indicating reproduced transform coefficient information item.

The inverse transform unit 503 receives the reproduction transform coefficient information item from the inverse quantizer 502, inverse transforms the reproduction transform coefficient information item, and generates a reproduction residual signal indicating a reproduced residual signal.

The adder 504 receives the reproduction residual signal from the inverse transform unit 503, and receives the prediction image signal from the prediction image generator 509 explained later. Then, the adder 504 adds the reproduction residual signal and the prediction image signal to generate a decoded image signal.

The loop filter processor 505 performs the same operation as the loop filter processor 107 according to the first embodiment. More specifically, the loop filter processor 505 receives the loop filter information item from the variable-length decoder 501 and receives the decoded image signal from the adder 504, and performs filter processing on the decoded image signal based on the loop filter information item, thereby generating a reproduction image signal. The loop filter processor 505 also outputs the generated reproduction image signal to the outside.

The frame memory 506 receives the reproduction image signal from the loop filter processor 505, and accumulates the reproduction image signal.

The interpolation filter processor 508 performs the same operation as the interpolation filter processor 110 according to the first embodiment. More specifically, the interpolation filter processor 508 reads the reproduction image signal from the frame memory 506, performs the interpolation filter processing on the reproduction image signal, and generates a reference image of sub-pixel precision. In the generation of the reference image, the referenced pixel is generated according to the motion vector used in the motion compensation prediction from among the sub-pixels “a” to “o” of FIG. 2 and the integer-pixels.

The prediction image generator 509 receives the reference image from the interpolation filter processor 508, performs the motion compensation prediction of sub-pixel precision using the reference image, and generates a prediction image signal.

The decoding controller 510 controls the entire decoding apparatus 500. For example, the decoding controller 510 controls the amount of accumulation of the reproduction image signal in the frame memory 506, and controls the interpolation filter coefficients of the interpolation filter processor 508.

According to the second embodiment as explained above, the sub-pixel displaced by the quarter pixel from the integer-pixel is calculated from the integer-pixels, and the encoded signal can be decoded while preventing the high-frequency component of the interpolated reference image from being excessively decreasing, and therefore, the prediction efficiency of the motion compensation prediction can be improved.

### Third Embodiment

A video encoding apparatus according to the third embodiment is different from the first embodiment in that a loop filter processor includes a plurality of filters, and loop filter information item includes not only filter coefficient information item but also filter application information item and filter designation information item. The filter application information item is information for designating as to whether or not a filter is applied to a region in the screen. The filter designation information item is information for designating a filter to be applied.

The loop filter processor can determine whether a filter is to be applied or not on the basis of the loop filter information item, and further can select and switch a filter to be applied.

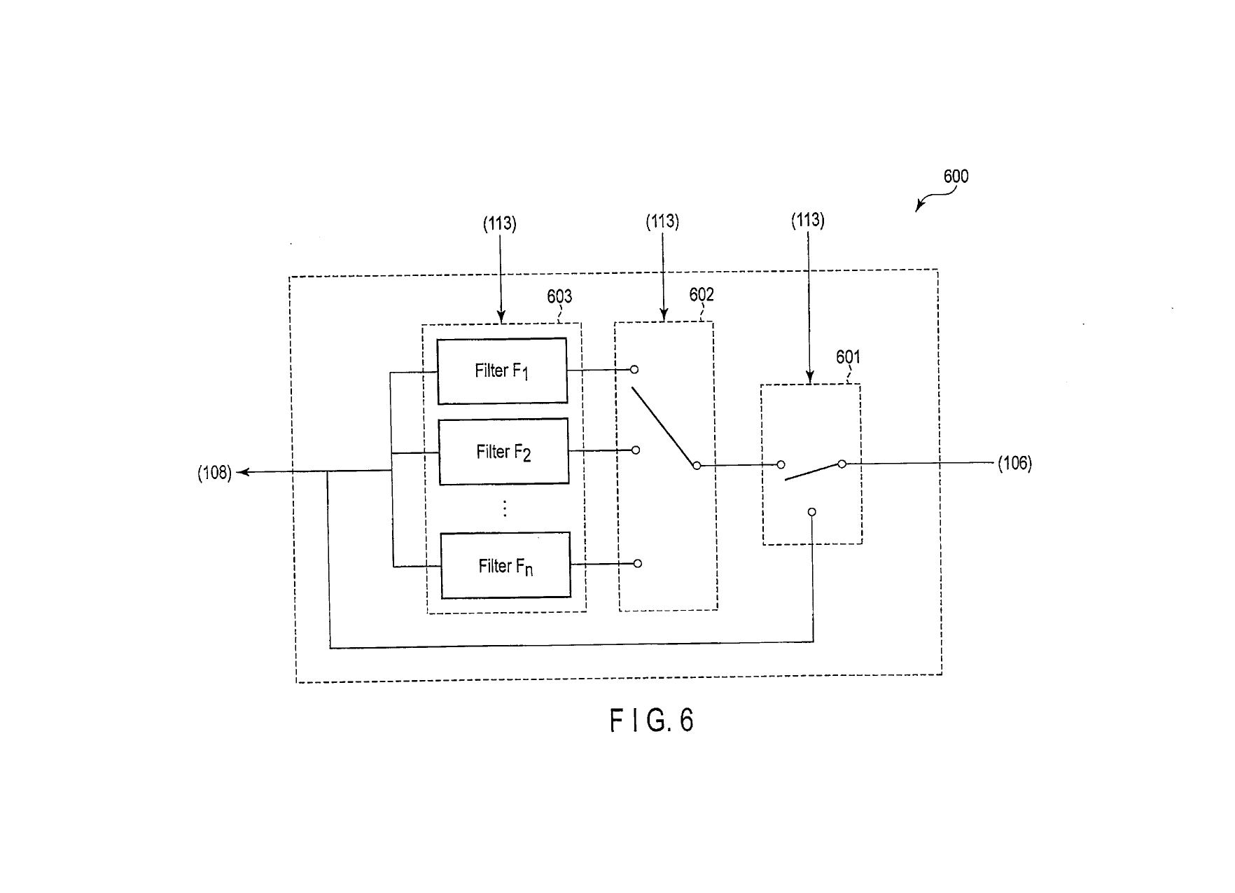

The loop filter processor of the video encoding apparatus according to the third embodiment will be explained in detail with reference to FIG. 6.

A loop filter processor 600 includes switch 601 and switch 602 and a filter unit 603.

The switch 601 receives a local decoded image signal from an adder 106 and receives loop filter information item from an encoding controller 102, and refers to the filter application information item included in the loop filter information item, thereby switching the output destination of the local decoded image signal.

The switch 602 receives the loop filter information item from the encoding controller 102, and refers to the filter designation information item included in the loop filter information item, thereby sending the local decoded image signal to the filter designated in the filter unit 603 explained later.

The filter unit 603 includes one or more filters (in FIG. 6, filter F₁, filter F₂, . . . , filter Fₙ (n is natural number)), and receives the loop filter information item from the encoding controller 102. Then, a filter unit 603 refers to the filter coefficient information item included in the loop filter information item, sets the filter coefficients to the designated filter, performs the filter processing on the local decoded image signal, and generates a reproduction image signal.

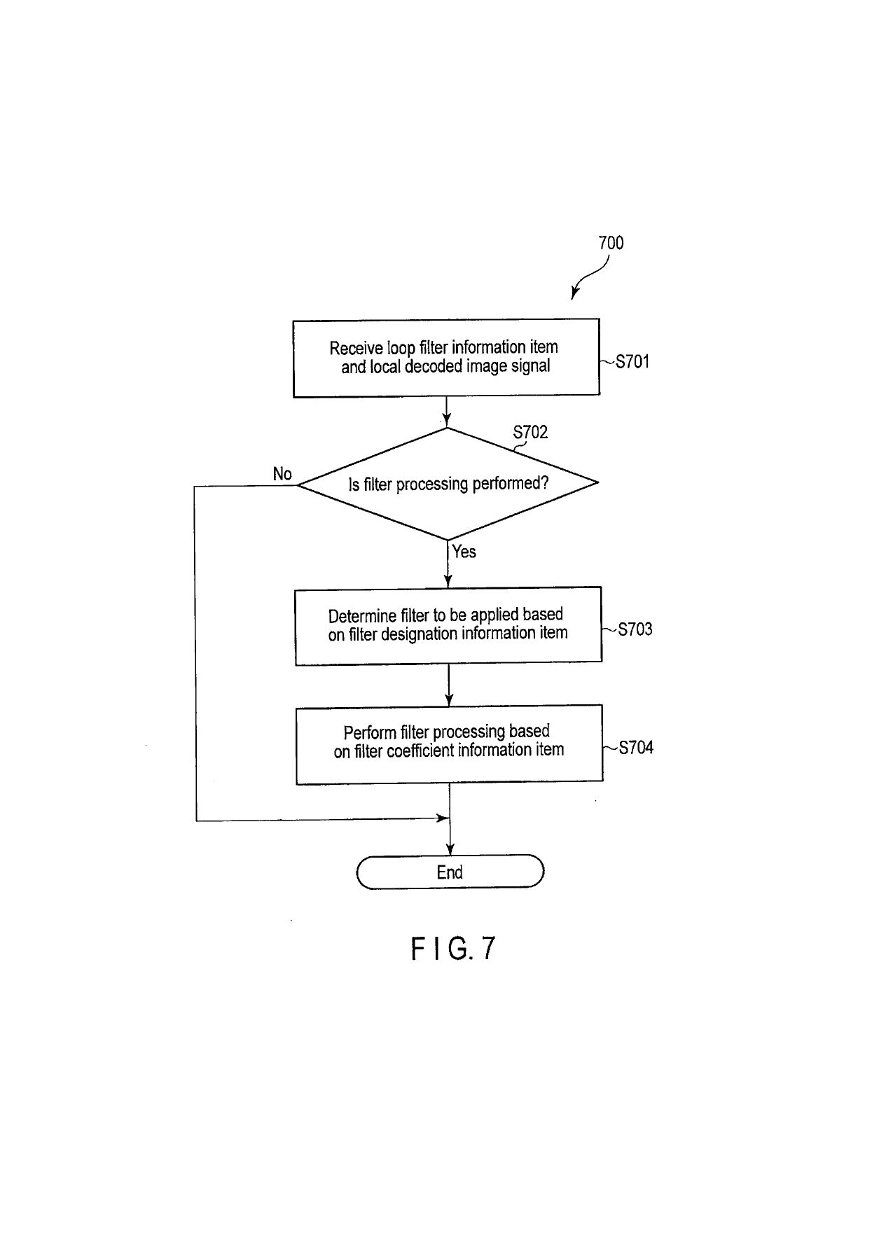

Subsequently, operation of the loop filter processor 600 will be explained in detail with reference to a flowchart of FIG. 7.

In step S701, the loop filter processor 600 receives the loop filter information item and the local decoded image signal.

In step S702, the switch 601 determines whether the filter processing is performed or not based on the filter application information item. When the filter application information item is information indicating that a filter is applied to a region in the screen, the switch 601 sends the local decoded image signal to the switch 602. On the other hand, when the filter application information item is information indicating that a filter is not applied to a region in the screen, the switch 601 terminates without performing the filter processing on the local decoded image signal. In this case, the switch 601 sends the local decoded image signal to the frame memory 108.

In step S703, when the local decoded image signal is sent from the switch 601, the switch 602 determines a filter to be applied based on the filter designation information item.

In step S704, when the local decoded image signal is sent to the filter designated by the switch 602, the filter processing is performed upon setting the filter coefficients to the filter designated based on the filter coefficient information item. As described above, the operation of the loop filter processor 600 is terminated.

Instead of sending the loop filter information item to the switch 601 and the switch 602 and the filter unit 603, information required by the switch 601 and the switch 602 and the filter unit 603 may be sent. More specifically, when the loop filter processor 600 receives the loop filter information item, the loop filter processor 600 may separate the filter application information item, the filter designation information item, and the filter coefficient information item included in the loop filter information item, and may send the filter application information item to the switch 601, the filter designation information item to the switch 602, and the filter coefficient information item to the filter unit 603.

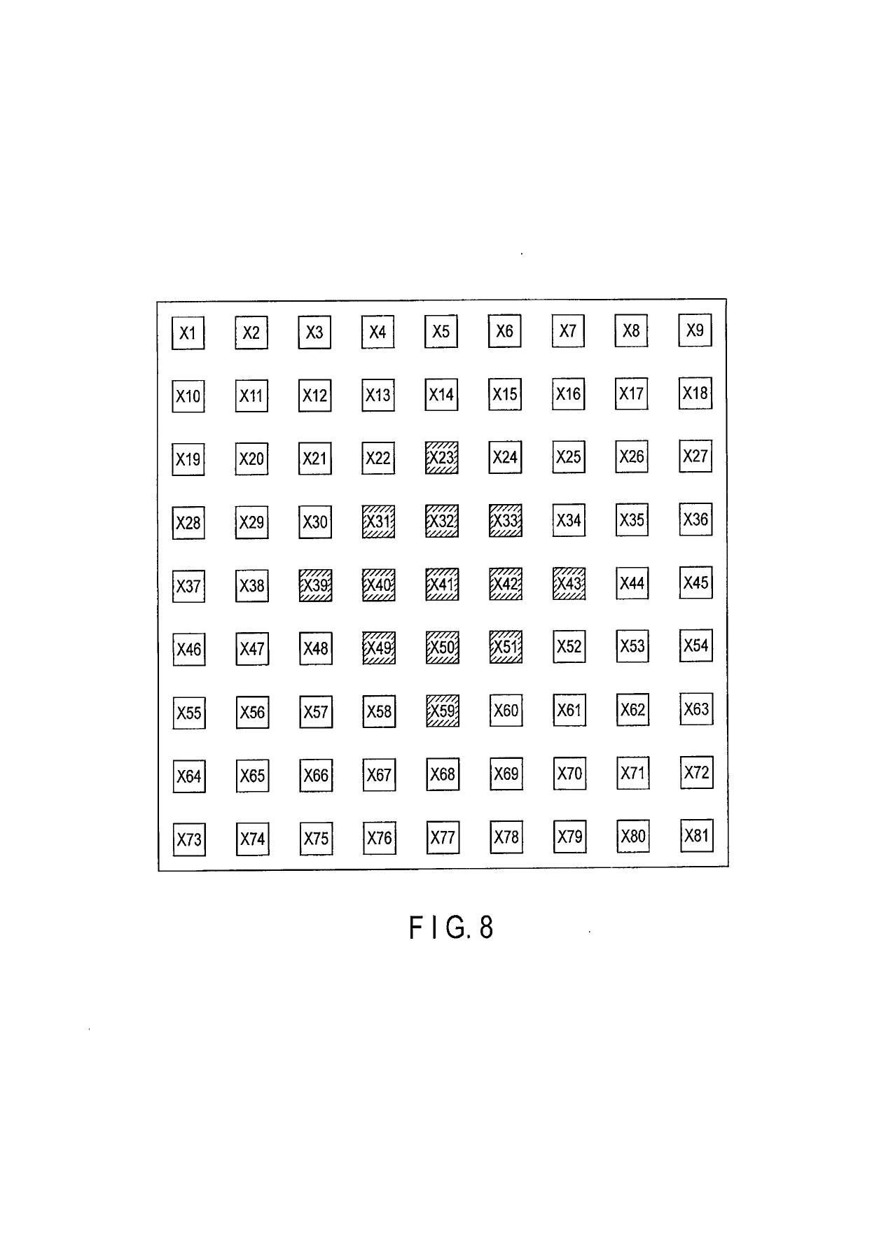

In this case, an example of a filter included in the filter unit 603 will be explained in detail with reference to FIGS. 8 to 12.

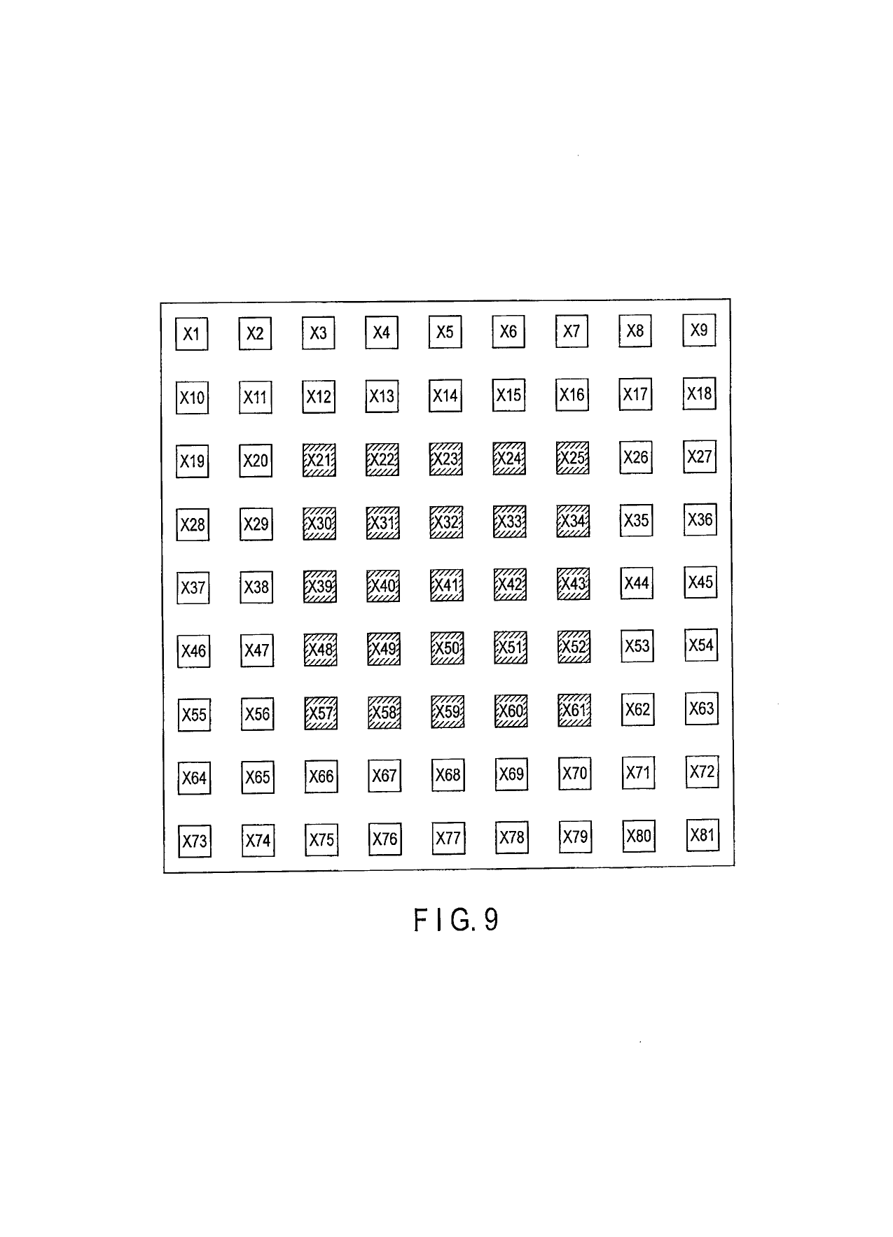

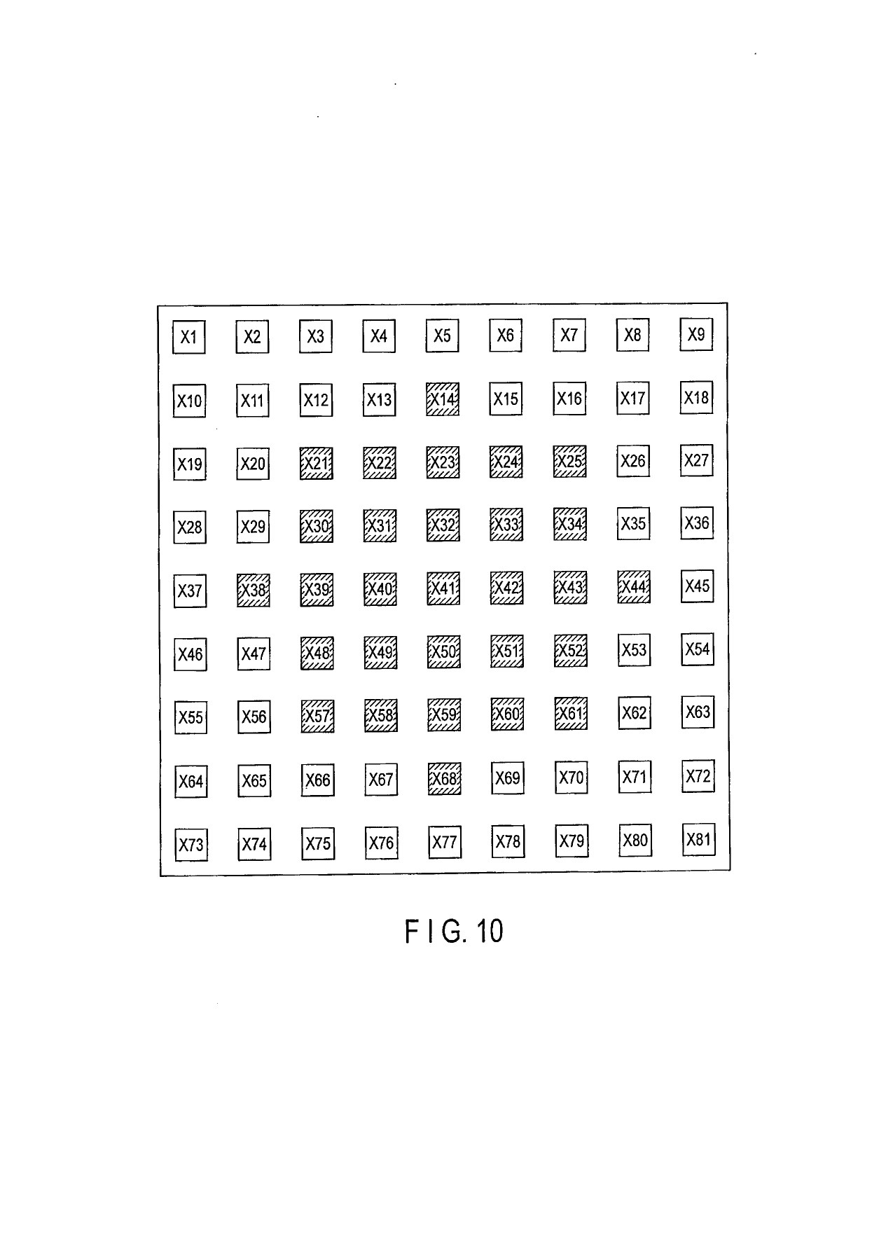

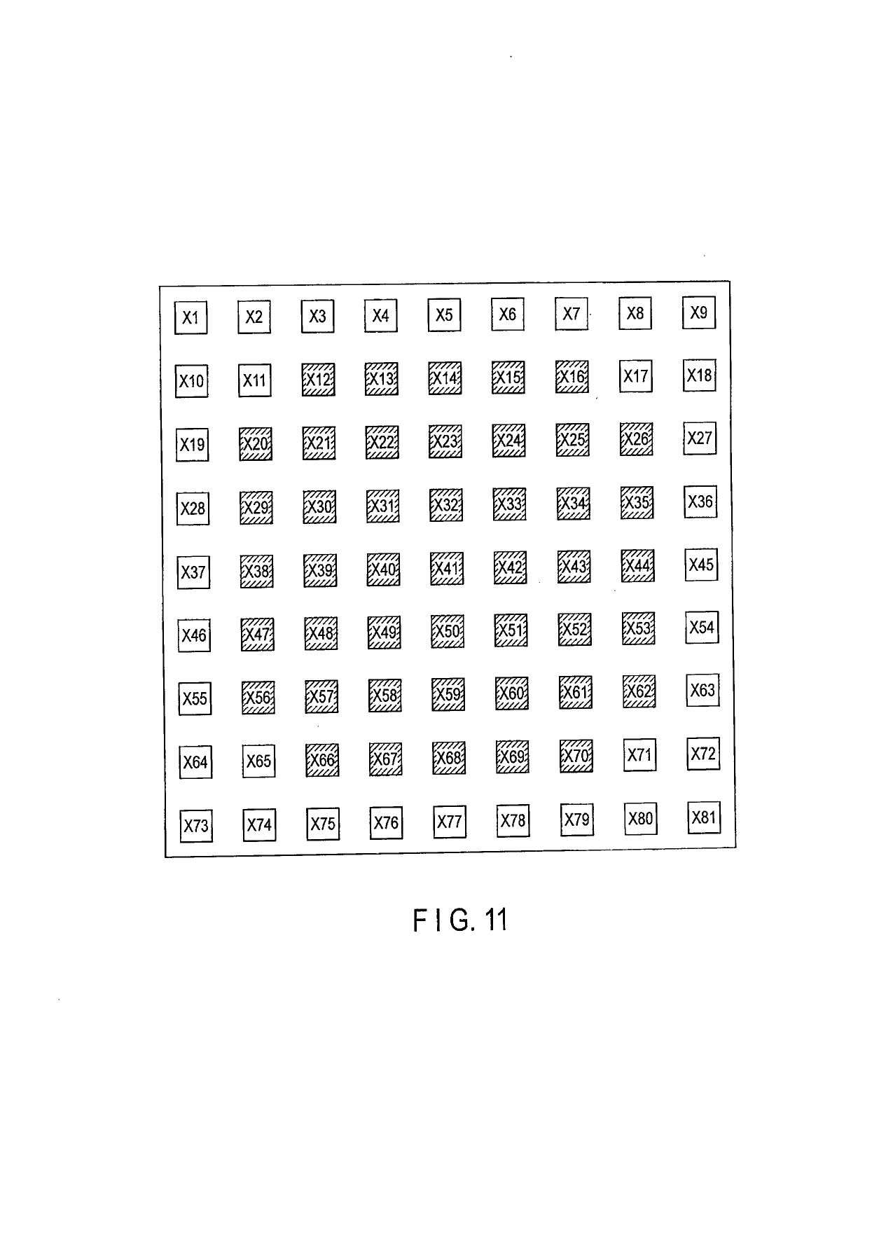

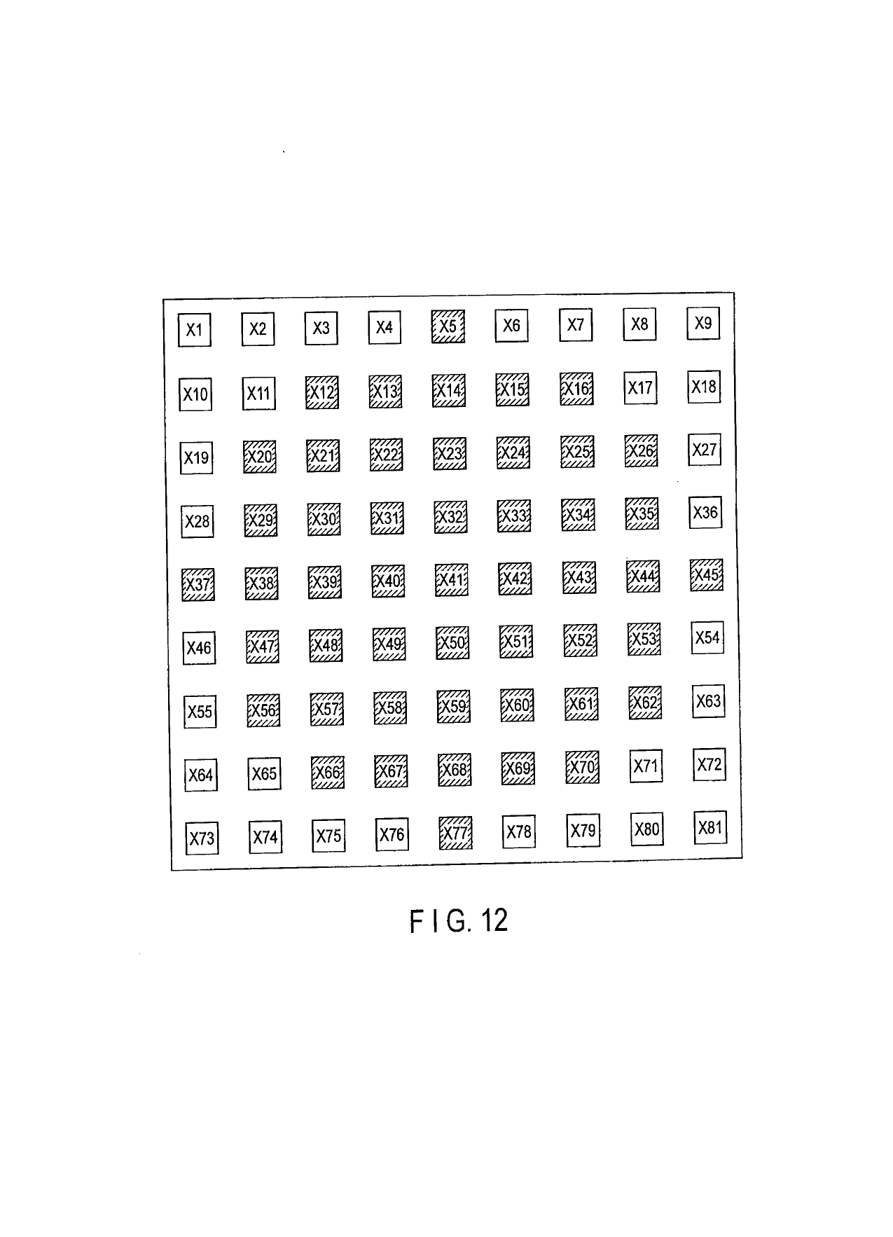

X1 to X81 as shown in FIGS. 8 to 12 are integer-pixels of a local decoded image represented as a 9×9 square. X41 denotes a target pixel to be subjected to the filter processing. FIG. 8 denotes a filter F₁, FIG. 9 denotes a filter F₂, FIG. 10 denotes a filter F3, FIG. 11 denotes a filter F₄, and FIG. 12 denotes a filter F₅. Filter processing using the filter F₁ as shown in FIG. 8 will be explained as a specific example, but the same method can also be applied to other filters.

Each filter has a different number of integer-pixels used for the filter processing according to the Euclidean distance from the filter processing target pixel. In other words, the number of integer-pixels from the filter processing target pixel to an integer-pixel in the horizontal direction or the vertical direction is adopted as a radius, and integer-pixels included in a circle indicating a pixel region drawn by the radius are used for the filter processing. For example, for the filter F₁, a circle is drawn with a radius of two pixels from X41, i.e., the filter processing target pixel, to X43, and integer-pixels included inside of the circle are used for the filter processing. In the case of FIG. 8, totally 13 integer-pixels X23, X31, X32, X33, X39, X40, X41, X42, X43, X49, X50, X51, and X59 indicated by diagonal lines are used for the filter processing. In this case, the distance of two pixels from the filter processing target pixel will be described that the Euclidean distance R(F₁) of the filter F₁ is two. The other filters are similar to the above, and the Euclidean distances R(F₂), R(F₃), R(F₄), R(F₅) of the filter F₂ of FIG. 9, the filter F₃ of FIG. 10, the filter F₄ of FIG. 11, and the filter F₅ of FIG. 12 are as follows.

R(F₂)=2\sqrt{2},

R(F₃)=3,

R(F₄)=\sqrt{13},

R(F₅)=4

The interpolation filter processor 110 performs the filter processing using expression (26).

$${X}^{′} 41 = ( {\sum }_{i ∈ I ( {F}_{1} )} {h}_{i}^{1} Xi + 128 ) >> 8 \qquad ( 26 )$$

In this case, the indexes of the pixels used for the filter processing are defined as follows, I(F₁)={23, 31, 32, 33, 39, 40, 41, 42, 43, 49, 50, 51, 59}. On the other hand, expression (27) represents the filter coefficient.

$${\{ {h}_{i}^{1} \}}_{i} \qquad ( 27 )$$

The filter processing of the filter F₁ performs a fewer number of operations than the filter processing performed by the loop filter processor 107 according to the first embodiment. More specifically, in the filter processing performed by the loop filter processor 107 according to the first embodiment, the number of additions and multiplications is 81 times as shown in expression (25). In contrast, in the filter processing performed by the loop filter processor 505 according to the second embodiment, the number of additions and multiplications is only 13 times as shown in expression (26). In expression (25), the number of filter coefficients is 81, whereas in expression (26), the number of filter coefficients is 13. Therefore, the amount of coding relating to the filter coefficients can be reduced.

The expression (26) relating to the filter processing of the filter F₁ uses pixels of which distance from the filter processing target pixel is short and of which correlation with the filter processing target pixel is high. For this reason, even when the number of filter coefficients is reduced, this can prevent great reduction of the effect of removing encoding distortion of the filter processing as compared with the loop filter processor 107 according to the first embodiment, and this is effective in reducing the amount of processing of operation.

It should be noted that the filter coefficients may not be set for all the integer-pixels used for the filter processing, and the filter coefficients may be set using symmetrical property with respect to the filter processing target pixel. For example, in the filter F₁, the filter coefficients of the integer-pixels at the positions symmetrical about the point of the filter processing target pixel. X41 as shown in expression (28), expression (29), expression (30) may be set at the same value.

h₂₃¹=h₅₉¹ (28)

h₃₁₊ₖ¹=h₅₁₋ₖ¹(k=0,1,2) (29)

h₃₉₊ₖ¹=h₄₃₋ₖ¹(k=0,1) (30)

Therefore, the filter coefficients as shown in expression (31) may be set as filter coefficients sent to the loop filter processor 107.

$$\{ {h}_{23}^{1} , {h}_{31}^{1} , {h}_{32}^{1} , {h}_{33}^{1} , {h}_{39}^{1} , {h}_{40}^{1} , {h}_{41}^{1} \} \qquad ( 31 )$$

The encoding controller 102 generates loop filter information item including these filter coefficients, and the variable-length encoder 112 encodes the loop filter information item. When this kind of symmetrical property is utilized, the number of multiplications and the amount of code of filter coefficients can be reduced as compared with the case where the symmetrical property is not used.

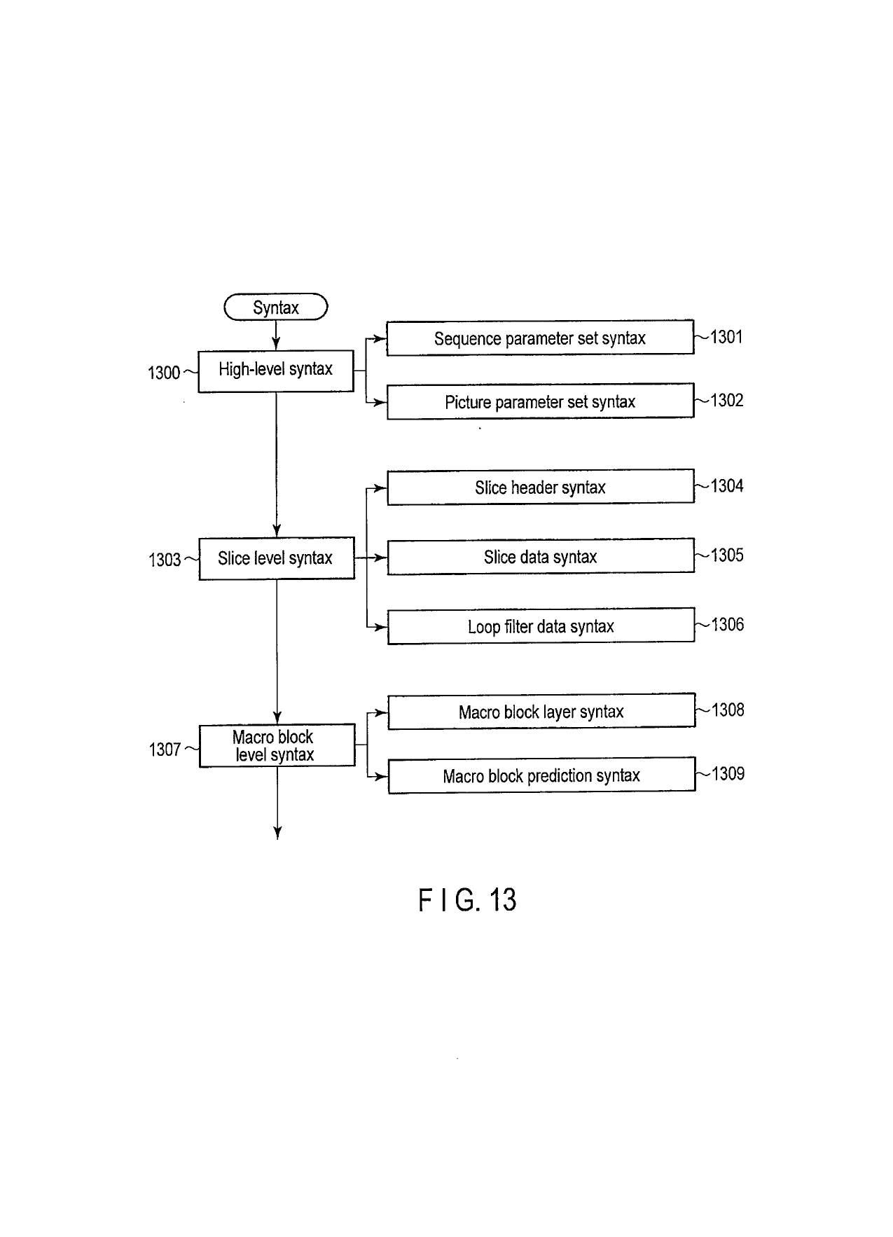

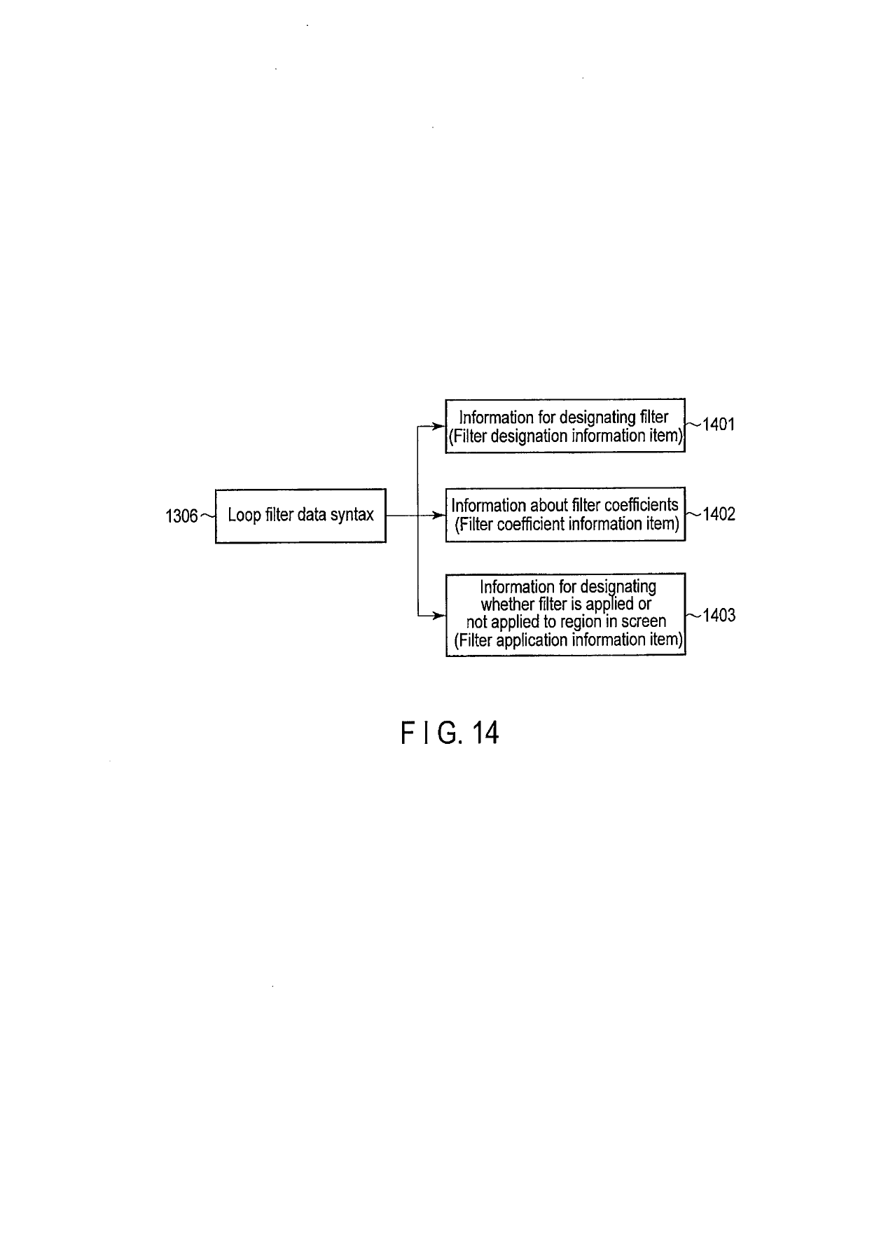

Subsequently, an example of syntax structure used in the third embodiment will be explained with reference to FIGS. 13 and 14.

The syntax mainly includes three parts, and a high-level syntax 1300 describes syntax information of an upper layer of slice or higher. A slice level syntax 1303 describes information required for each slice. A macro block level syntax 1307 describes, e.g., transform coefficient data, a prediction mode, and a motion vector required for each macro block.

Each syntax includes further detailed syntax. The high-level syntax 1300 includes syntaxes of sequence or picture level such as a sequence parameter set syntax 1301 and a picture parameter set syntax 1302. The slice level syntax 1303 includes a slice header syntax 1304, a slice data syntax 1305, and a loop filter data syntax 1306. Further, the macro block level syntax 1307 includes a macro block layer syntax 1308 and a macro block prediction syntax 1309.

Further, as shown in FIG. 14, the loop filter data syntax 1306 describes loop filter information item, i.e., a parameter relating to a loop filter. The loop filter data syntax 1306 includes filter designation information item 1401, filter coefficient information item 1402, and filter application information item 1403.

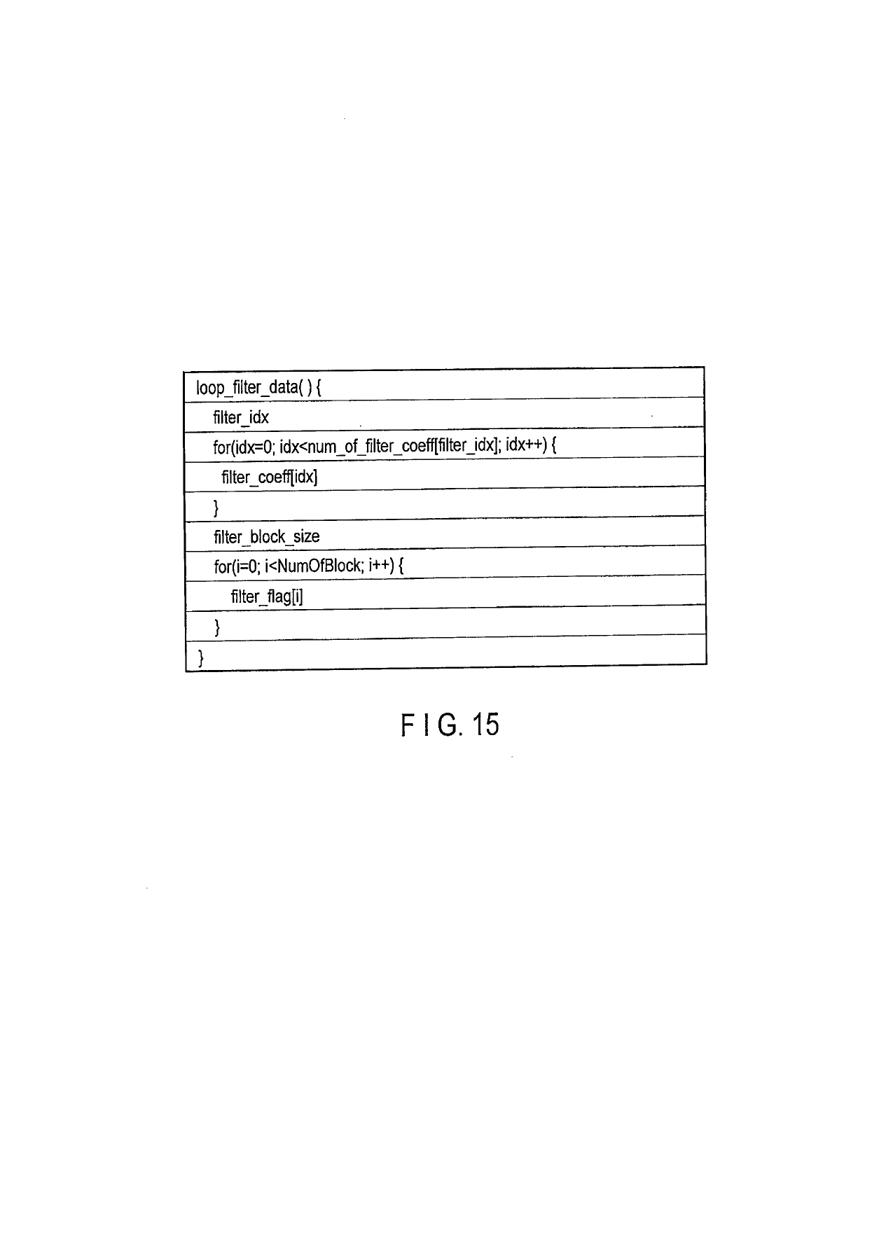

Subsequently, an example of the loop filter data syntax 1306 will be explained in detail with reference to FIG. 15.

filter_idx denotes filter designation information item. For example, when the filter unit 503 includes the five filters already explained above, numerical values 0, 1, 2, 3, and 4 may be used to designate a filter from among the filter F₁ to the filter F₅. That is, filter_idx is an index corresponding to each of Euclidean distances R(F₁), R(F₂), R(F₃), R(F₄) and R(F₅), i.e., radiuses of circles representing pixel regions used for filter processing from the filter F₁ to the filter F₅. Therefore, the loop filter processor 107 can select a filter by reference to the index of filter_idx.

num_of_filter_coeff [filter_idx] denotes the number of coefficients of the filter designated by filter_idx, and the filter coefficients as many as the number designated by this value are sent to the loop filter processor 107. For example, when filter_idx designates the filter F₁, the value of num_of_filter_coeff [filter_idx] is 13.

filter_coeff [idx] denotes idx-th coefficient of the designated filter. Differential information between filter coefficients predicted using filter coefficients used in an encoded slice and filter coefficients actually designed for the slice may be used for filter_coeff [idx].

filter_block_size denotes the size of a block (hereinafter referred to as division unit block) serving as a unit for dividing regions of the screen. NumOfBlock denotes the number of division unit blocks included in the slice, and filter application information item for the number of regions designated by this value is sent to the loop filter processor 107. For example, 16×16 is designated as the size of the division unit block in the slice of 320×240, the value of NumOfBlock is 300.

filter_flag [i] denotes filter application information item for the i-th division unit block. For example, when filter_flag[i] is 1, the filter is applied to the i-th division unit block, and when filter_flag[i] is 0, the filter is not applied.

According to the third embodiment as explained above, the loop filter processor can determine whether to apply the filter or not based on the loop filter information item, and further, the filter to be applied can be selected and switched. The number of filter coefficients can be reduced by selecting an integer-pixel strongly correlated to the filter processing target pixel and applying it to the filter processing, and the amount of code relating to the filter coefficients can be reduced. Further, by using the symmetrical property with regard to the filter processing target pixel, the number of filter coefficients can be further reduced, and the rate can be reduced.

### Fourth Embodiment

A video decoding apparatus according to the fourth embodiment is almost the same as the video decoding apparatus according to the second embodiment as shown in FIG. 5, but is different therefrom in that the loop filter processor 505 performs the same operation as a loop filter processor 600 according to the third embodiment 600. The video decoding apparatus according to the fourth embodiment receives encoded data that are output by the video encoding apparatus according to the third embodiment.

According to the syntax structure as shown in FIG. 13, the variable-length decoder 501 processes a code string of each syntax of encoded data for each of the high-level syntax 1300, the slice level syntax 1303, and the macro block level syntax 1307 in order, and decodes, e.g., quantized transform coefficient information item and loop filter information item. When it is the same loop filter data syntax 1306 as the third embodiment, the filter to be applied is designated by reference to the index of filter_idx, and the radius of the circle indicating the pixel region used for the filter processing can be identified.

According to the fourth embodiment explained above, the encoded data subjected to the filter processing by the video encoding apparatus according to the third embodiment can be decoded based on the filter application information item, the filter designation information item, and the filter coefficient information item included in the loop filter information item.

### Fifth Embodiment

In general, the video encoding technique has two objects to perform pixel interpolation of sub-pixel precision in the motion compensation prediction. The first object is to generate a prediction image with a finer precision than integer unit in order to express the motion precision of objects within the image more correctly. The second object is the effect of removing encoding distortion by using a low-pass filter as the interpolation filter.

For example, in H.264/AVC, the interpolation filter processing is performed with a precision up to the quarter pixel precision, but the pixel value at a position of quarter pixel precision is an average value of two pixel values at the positions of the integer precision or the half pixel precision. This makes a strong low-pass filter using the average value with regard to the positions of quarter pixel precision, and therefore, the second object is achieved. In this motion compensation prediction, the method for performing the pixel interpolation of sub-pixel precision may be considered to be adaptive filter processing according to selection of a pixel position with motion vector as a result. For the second object, the method in which an interpolation filter processor uses the low-pass filter adopting an average value of two pixels or four pixels in the surrounding is widely employed in the international standardized specification such as MPEG-1, MPEG-2, H.263, MPEG-4 Visual, H.264/AVC.

In the present application, the configuration of the loop filter processor 107 achieves reduction of encoding distortion, which is the second object of the conventional interpolation filter processing. That is, the loop filter processor 107 uses the loop filter data syntax 1306 explained in FIGS. 13, 14 to achieve adaptive image decoding processing with regard to the pixel value of integer precision in the decoded image for every encoder. Therefore, in the interpolation filter processor 110, achievement of pure motion precision can be the object without considering removal of encoding distortion.

More specifically, for not only the half pixel precision but also the quarter pixel precision or the one-eighth pixel precision, FIR (Finite Impulse Response) filter using pixel values of a plurality of integer-pixel positions can be used without using the low-pass filter such as the average value filter.

A case will be considered where the interpolation filter processor 110 according to the present embodiment is applied to a video encoding apparatus not including the loop filter processor 107 according to the present embodiment. In this case, there is no effect of removal of encoding distortion, i.e., the second object, and therefore, the encoding efficiency decreases as compared with the case where the conventional interpolation filter processor is applied. When the conventional interpolation filter processor is applied to a video encoding apparatus including the loop filter processor 107 according to the present embodiment, it is necessary to use the low-pass filter for the second object. Therefore, with the effect of the low-pass filter, movement cannot be estimated correctly, and this reduces the degree of improvement of the encoding efficiency.

Therefore, a combination of the loop filter processor including the adaptive image-decoding filter as shown in the present embodiment and a high-precision interpolation filter processor for directly obtaining a pixel value at a sub-pixel position from integer-pixels has multiplier effect in improving the encoding efficiency. With regard to this point, the same effect can be also obtained for not only the luminance signal but also the color difference signal.

The video encoding apparatus according to the fifth embodiment performs operation made up with a combination of operations of the video encoding apparatus according to the first and third embodiments.

The video encoding apparatus according to the fifth embodiment will be explained with reference to FIG. 1.

The video encoding apparatus 100 according to the fifth embodiment includes a subtractor 101, a transform unit 102, a quantizer 103, an inverse quantizer 104, an inverse transform unit 105, an adder 106, a loop filter processor 107, a frame memory 108, an interpolation filter processor 110, a prediction image generator 111, a variable-length encoder 112, and an encoding controller 113.

The subtractor 101 receives an input image signal from the outside and receives a prediction image signal from the prediction image generator 111 explained later, and outputs, as a residual signal, a difference between the input image signal and the prediction image signal.

The transform unit 102 receives the residual signal from the subtractor 101, transforms the residual signal, and generates transform coefficient information item.

The quantizer 103 receives transform coefficient information item from the transform unit 102, quantizes the transform coefficient information item, and obtains quantized transform coefficient information item.

The inverse quantizer 104 receives the quantized transform coefficient information item from the quantizer 103, inverse quantizes the quantized transform coefficient information item, and generates reproduction transform coefficient information item.

The inverse transform unit 105 receives the reproduction transform coefficient information item from the inverse quantizer 104, inverse transforms the reproduction transform coefficient information item, and generates a reproduction residual signal, i.e., a reproduced residual signal.

The adder 106 receives the reproduction residual signal from the inverse transform unit 105 and receives the prediction image signal from the prediction image generator 111 explained later, and adds the reproduction residual signal and the prediction image signal, thereby generating a local decoded image signal.

The loop filter processor 107 receives the local decoded image signal from the adder 106 and receives the loop filter information item from the encoding controller 113 explained later, and performs filter processing on the local decoded image signal based on the loop filter information item, thereby generating a reproduction image signal. The loop filter information item includes filter application information item, filter designation information item, and filter coefficient information item. Based on the above information, the loop filter processor 107 can determine whether to apply a filter or not, and further select and switch a filter to be applied. With such processing, the loop filter processor 107 can perform image decoding processing on the local decoded image signal. It should be noted that specific operation of the loop filter processor will be explained later.

The frame memory 108 receives the reproduction image signal from the loop filter processor 107, and accumulates the reproduction image signal.

The interpolation filter processor 110 reads the reproduction image signal from the frame memory 108, performs filter processing on the reproduction image signal, and generates a reference image of sub-pixel precision.

The prediction image generator 111 receives the reference image from the interpolation filter processor 110 and receives the motion vector information from the encoding controller 113 explained later, and uses the reference image to perform motion compensation prediction of sub-pixel precision based on the motion vector information, and generates a prediction image signal based on the prediction mode information.

The variable-length encoder 112 receives the quantized transform coefficient information item from the quantizer 103, and respectively receives the prediction mode information, the loop filter information item, and the motion vector information from the encoding controller 113 explained later. Then, the variable-length encoder 112 encodes the quantized transform coefficient information item, the prediction mode information, the loop filter information item, and the motion vector information, and generates encoded data.

The encoding controller 113 generates motion vector information used for motion compensation prediction, determines prediction mode information, and designs the filter used in the loop filter processor 107 to generate the motion vector information and the loop filter information item.

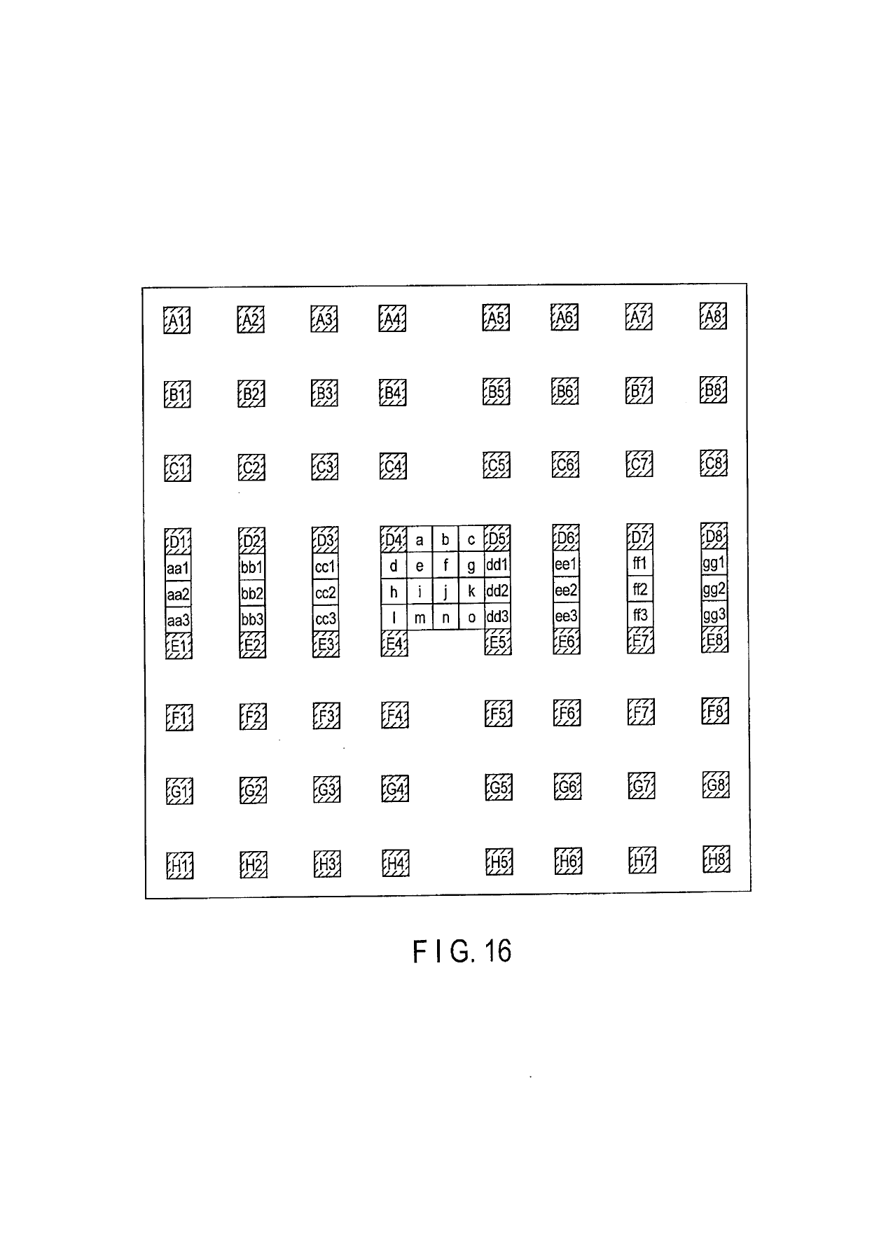

Subsequently, the interpolation filter processor 110 will be explained with reference to FIG. 16.

In FIG. 16, A1 to A8, B1 to B8, C1 to C8, D1 to D8, E1 to E8, F1 to F8, G1 to G8, H1 to H8 denote integer-pixels, and “a” to “o” denote sub-pixels to be interpolated.

In the fifth embodiment, eight tap asymmetrical FIR filter having filter coefficients [−1, 4, −10, 57, 19, −7, 3, −1] is used for sub-pixels “a” and “d” at quarter pixel precision positions displaced from the integer-pixel D4 by the quarter pixel. Eight tap symmetrical FIR filter having filter coefficients [−1, 5, −12, 40, 40, −12, 5, −1] is used for sub-pixels “b” and “h” at half pixel precision positions displaced by the half pixel. Asymmetrical FIR filter having filter coefficients [−1, 3, −7, 19, 57, −10, 4, −1] is used for sub-pixels “c” and “l” at three fourths pixel precision positions displaced by three quarter pixel. The method for achieving this will be explained in the method for achieving addition/subtraction and shift operation in the present embodiment. In this case, a function “Clip” limits the input value to a value between the minimum value and the maximum value of the pixel value. “<<” denotes left logical shift operator, and “>>” denotes right logical shift operator.

First, for the sub-pixels “a”, “b” and “c”, interpolation values are generated by applying one-dimensional FIR filter in the horizontal direction. More specifically, the interpolation values of the sub-pixels “a”, “b” and “c” are respectively obtained by operation from expression (32) to expression (34) as follows.

AA1=D4+D6

AA2=D5+D7

AA3=AA1+AA2−D1−D8

AA4=AA2−D3

AA5=AA1+D3

AA6=AA3+(AA4<<1)+(D2<<2)+(AA5<<3)+(D5<<4)+(D4<<6)

a=Clip((AA6+32)>>6) (32)

BB1=D1+D8

BB2=D2+D7

BB3=D3+D6

BB4=D4+D5

BB5=(BB4<<5)+((−BB3+BB4)<<3)+((BB2−BB3)<<2)−BB1+BB2

b=Clip((BB5+32)>>6) (33)

CC1=D3+D5

CC2=D2+D4

CC3=CC1+CC2−D1−D8

CC4=CC2−D6

CC5=CC1+D6

CC6=CC3+(CC4<<1)+(D7<<2)+(CC5<<3)+(D4<<4)+(D5<<6)

c=Clip((CC6+32)>>6) (34)

For the sub-pixels “d”, “h” and “1”, interpolation values are generated by applying one-dimensional FIR filter in the vertical direction. More specifically, the interpolation values thereof are obtained by operation from expression (35) to expression (37) as follows.

DD1=D4+F4

DD2=E4+G4

DD3=DD1+DD2−A4−H4

DD4=DD2−C4

DD5=DD1+C4

DD6=DD3+(DD4<<1)+(B4<<2)+(DD5<<3)+(E4<<4)+(D4<<6)

d=Clip((DD6+32)>>6) (35)

HH1=A4+H4

HH2=B4+G4

HH3=C4+F4

HH4=D4+E4

HH5=(HH4<<5)+((−HH3+HH4)<<3)+((HH2−HH3)<<2)−HH1+HH2

h=Clip((HH5+32)>>6) (36)

LL1=C4+E4

LL2=B4+D4

LL3=LL1+LL2−A4−H4

LL4=LL2−F4

LL5=LL1+F4

LL6=LL3+(LL4<<1)+(G4<<2)+(LL5<<3)+(D4<<4)+(E4<<6)

l=Clip((LL6+32)>>6) (37)

Unlike the sub-pixels “a”, “b”, “c”, “d”, “h” and “l” explained above, interpolation values for the sub-pixels “e”, “f”, “g”, “i”, “j”, “k”, “m”, “n” and “o” are generated by applying one-dimensional FIR filter in the horizontal direction to the intermediate values generated by applying the one-dimensional FIR filter in the vertical direction.

First, for the sub-pixels “e”, “f” and “g”, the same method as the first half of the steps of the method for generating the interpolation value of the sub-pixel “d” is applied, i.e., intermediate values aa1, bb1, cc1, DD6, dd1, ee1, ff1, gg1 are generated by applying the one-dimensional FIR filter in the vertical direction, and then, like the method for generating the interpolation values for the sub-pixels “a”, “b” and “c”, the interpolation values are generated by applying the FIR filter in the horizontal direction.

Now, generation of the interpolation value of the sub-pixel “e” will be explained.

First, for the sub-pixel aa1, the intermediate value is obtained using operation with expression (38) shown below using the integer-pixels A1, B1, C1, D1, E1, F1, G1, H1.

EE1−D1+F1

EE2=E1+G1

EE3=EE1+EE2−A1−H1

EE4=EE2−C1

EE5=EE1+C1

aa1=EE3+(EE4<<1)+(B1<<2)+(EE5<<3)+(E1<<4)+(D1<<6) (38)

Likewise, the intermediate value of the sub-pixel bb1 is also obtained using operation with expression (38) using the integer-pixels A2, B2, C2, D2, E1, F2, G2, H2.

Likewise, the intermediate value of the sub-pixel cc1 is also obtained using operation with expression (38) using the integer-pixels A3, B3, C3, D3, E3, F3, G3, H3.

For the sub-pixel “d”, DD6 of expression (35) may be used as the intermediate value.

Likewise, the intermediate value of the sub-pixel dd1 is also obtained using operation with expression (38) using the integer-pixels A5, B5, C5, D5, E5, F5, G5, H5.

Likewise, the intermediate value of the sub-pixel ee1 is also obtained using operation with expression (38) using the integer-pixels A6, B6, C6, D6, E6, F6, G6, H6.

Likewise, the intermediate value of the sub-pixel ff1 is also obtained using operation with expression (38) using the integer-pixels A7, B7, C7, D7, E7, F7, G7, H7.

Likewise, the intermediate value of the sub-pixel gg1 is also obtained using operation with expression (38) using the integer-pixels A8, B8, C8, D8, E8, F8, G8, H8.

The interpolation value of the pixel “e” can be generated using operation with expression (39) shown below using the eight points of intermediate values calculated according to the above method, i.e., aa1, bb1, cc1, DD6, dd1, ee1, ff1, gg1.

EE6=DD6+ee1

EE7=dd1+ff1

EE8=EE6+EE6−aa1−gg1

EE9=EE7−cc1

EE10=EE6+cc1

EE11=EE8+(EE9<<1)+(bb1<<2)+(EE10<<3)+(dd1<<4)+(DD6<<6)

e=Clip((EE11+2048)>>12) (39)

Likewise, the interpolation values of the sub-pixels “f” and “g” can be generated by applying the FIR filter in the horizontal direction using the eight points of intermediate values, i.e., aa1, bb1, cc1, DD6, dd1, ee1, ff1, gg1.

First, for the sub-pixels “i”, “j” and “k”, the same method as the first half of the steps of the method for generating the interpolation value of the sub-pixel “h” is applied, i.e., intermediate values aa2, bb2, cc2, HH5, dd2, ee1, ff2, gg2 are generated by applying the one-dimensional FIR filter in the vertical direction. Then, like the method for generating the interpolation values for the sub-pixels “a”, “b” and “c”, the interpolation values are generated by applying the FIR filter in the horizontal direction.

First, for the sub-pixels “m”, “n” and “o”, the same method as the first half of the steps of the method for generating the interpolation value of the sub-pixel “l” is applied, i.e., intermediate values aa3, bb3, cc3, LL6, dd3, ee3, ff3, gg3 are generated by applying the one-dimensional FIR filter in the vertical direction. Then, like the method for generating the interpolation values for the sub-pixels “a”, “b” and “c”, the interpolation values are generated by applying the FIR filter in the horizontal direction.

By applying the above processing to each sub-pixel, the interpolation value of each sub-pixel can be calculated.

Subsequently, the loop filter processor 107 will be explained with reference to FIG. 6.

The interpolation filter processor 110 uses a fixed filter coefficient defined in advance. In contrast, the loop filter processor 107 performs adaptive image decoding processing using the filter application information item, the filter coefficient information item, and the filter designation information item designed by the encoding controller 113. Due to the loop filter, the encoding controller 113 designs the filter and the filter coefficients allowing image decoding from the input image and the local decoded image, and adopts them as filter designation information item and filter coefficient information item, respectively. Further, the encoding controller 113 determines whether to apply or not apply a filter to a region in the screen. Then, the encoding controller 113 determines to apply the filter to the region in which the local decoded image is decoded from the input image by the filter processing, and determines not to apply the filter to the regions other than the above. The encoding controller 113 uses the determined result as the filter application information item.

The loop filter processor 107 includes a switch 601, a switch 602, and a filter unit 603. The filter unit 603 includes a plurality of filters. The loop filter processor 107 receives the loop filter information item from the encoding controller 113. The loop filter information item includes the filter designation information item, the filter coefficient information item, and the filter application information item. The loop filter information item is given as follows. The filter designation information item is input to the switch 602. The filter coefficient information item is input to a filter unit 603. The filter application information item is input to the switch 601.

The switch 601 switches the output destination of the local decoded image signal based on the filter application information item for the region in the screen. The local decoded image signal is sent as follows. When the filter is applied, the image signal in the designated region is output to the switch 602. When the filter is not applied, the image signal in the designated region is output to the outside of the loop filter processor 107 without passing through the switch 602 and the filter unit 603.

The switch 602 gives the local decoded image signal to the designated filter on the basis of the filter designation information item.

The filter unit 603 sets filter coefficients to the designated filter based on the filter coefficient information item, performs filter processing on the local decoded image signal, and generates an image signal.

An example of syntax structure used in the fifth embodiment will be explained with reference to FIGS. 13 and 14.

The syntax mainly includes three portions, and a high-level syntax 1300 describes syntax information of an upper layer of slice or higher. A slice level syntax 1303 describes information required for each slice. A macro block level syntax 1307 describes, e.g., transform coefficient data, a prediction mode, and a motion vector required for each macro block.

Each syntax includes further detailed syntax. The high-level syntax 1300 includes syntaxes of sequence or picture level such as a sequence parameter set syntax 1301 and a picture parameter set syntax 1302. The slice level syntax 1303 includes a slice header syntax 1304, a slice data syntax 1305, and a loop filter data syntax 1306. Further, the macro block level syntax 1307 includes a macro block layer syntax 1308 and a macro block prediction syntax 1309.

Further, as shown in FIG. 14, the loop filter data syntax 1306 describes loop filter information item indicating a parameter relating to a loop filter. The loop filter data syntax 1306 includes filter designation information item 1401, filter coefficient information item 1402, and filter application information item 1403.

In the fifth embodiment, the method for achieving the quarter pixel precision interpolation processing using the eight tap asymmetrical and symmetrical FIR filters has been explained. The method for achieving this using addition/subtraction and shift operation has been explained. Alternatively, it is to be understood that this can also be achieved using the method for performing the filter processing by multiplying the integer-pixel value by the filter coefficients. This processing may be used for the luminance signal or may be used for the color difference signal. For example, when sampling rates of the luminance signal and the color difference signal are different, and for example, the format is 4:2:0, the number of pixels of color difference is half both in the vertical and horizontal directions. Therefore, in order to adjust the scale, the following method may be employed. When the luminance signal is the quarter pixel precision interpolation processing, the color difference signal is subjected to interpolation processing of one-eighth pixel precision, and when the brightness signal is eight taps, it is subjected to four tap processing.

In the conventional method, when a filter having a long tap length is applied to the interpolation filter processing, there is encoding distortion in the integer-pixel value, and ringing distortion occurs in the interpolation image, which reduces the encoding efficiency. Therefore, in H.264/AVC, a filter of which tap length is six taps is used for the luminance signal. In the present embodiment, however, the integer-pixel value from which encoding distortion has been removed can be obtained by combining it with the loop filter processing including the adaptive image decoding filter, and therefore, it is possible to apply a filter having a long tap length, which could not be applied as the interpolation filter. For example, filters with longer tap lengths than those in the past, such as eight taps, ten taps, twelve taps, are effective. More specifically, an example of twelve taps will be shown. Twelve-tap asymmetrical FIR filter having filter coefficients [−1, 5, −12, 20, −40, 229, 76, −32, 16, −8, 4, −1] is used for the sub-pixels “a” and “d” of quarter pixel precision positions displaced from the integer-pixel D4, as a reference, by the quarter pixel. Twelve-tap symmetrical FIR filter having filter coefficients [−1, 8, −16, 24, −48, 161, 161, −48, 24, −16, 8, −1] is used for the sub-pixels “b” and “h” of half pixel precision positions displaced by the half pixel. Twelve-tap asymmetrical FIR filter having filter coefficients [−1, 4, −8, 16, −32, 76, 229, −40, 20, −12, 5, −1] may be used for the sub-pixels “c” and “1” of three-quarter pixel precision positions displaced by the three-quarter pixel.

According to the fifth embodiment explained above, the encoding efficiency can be enhanced synergistically using the combination of the loop filter processor including the adaptive image decoding filter and the interpolation filter processor of high precision for directly obtaining the pixel value at the sub-pixel position from the integer-pixels.

### Sixth Embodiment

A video decoding apparatus according to the sixth embodiment performs operation of a combination of operations of the video decoding apparatuses according to the second embodiment and the fourth embodiment.

The video decoding apparatus according to the sixth embodiment will be explained in detail with reference to FIG. 2.

The video decoding apparatus 500 according to the sixth embodiment includes a variable-length decoder 501, an inverse quantizer 502, an inverse transform unit 503, an adder 504, a loop filter processor 505, a frame memory 506, an interpolation filter processor 508, a prediction image generator 509, and a decoding controller 510.

The variable-length decoder 501 receives encoded data generated by the video encoding apparatus 100 according to the fifth embodiment. According to the syntax structure as shown in FIG. 13, the variable-length decoder 501 processes a code string of each syntax of encoded data for each of the high-level syntax 1300, the slice level syntax 1303, and the macro block level syntax 1307 in order, and decodes the encoded quantized transform coefficient information item, the encoded loop filter information item, and the encoded motion vector information. As a result, quantized transform coefficient information item, prediction mode information, loop filter information item, and motion vector information can be obtained.

The inverse quantizer 502 receives the quantized transform coefficient information item from the variable-length decoder 501, inverse quantizes the quantized transform coefficient information item, and generates reproduction transform coefficient information item.

The inverse transform unit 503 receives the reproduction transform coefficient information item from the inverse quantizer 502, inverse transforms the reproduction transform coefficient information item, and generates a reproduction residual signal.

The adder 504 receives the reproduction residual signal from the inverse transform unit 503, and receives the prediction image signal from the prediction image generator 509 explained later. The adder 504 adds the reproduction residual signal and the prediction image signal to generate a decoded image signal.

The loop filter processor 505 performs the same operation as the loop filter processor 107 according to the fifth embodiment. More specifically, the loop filter processor 505 receives the loop filter information item from the variable-length decoder 501 and receives the decoded image signal from the adder 504, and performs filter processing on the decoded image signal based on the loop filter information item, thereby generating a reproduction image signal. The loop filter processor 505 also outputs the generated reproduction image signal to the outside.

The frame memory 506 receives the reproduction image signal from the loop filter processor 505, and accumulates the reproduction image signal.

The interpolation filter processor 508 performs the same operation as the interpolation filter processor 110 according to the fifth embodiment. More specifically, the interpolation filter processor 508 reads the reproduction image signal from the frame memory 506, and receives the motion vector information from the variable-length decoder 501. The interpolation filter processing is performed on the reproduction image signal, and on the basis of the motion vector information, a reference image of sub-pixel precision is generated. In the generation of the reference image, the referenced pixel is generated according to the motion vector used in the motion compensation prediction from among the sub-pixels “a” to “o” of FIG. 16 and the integer-pixels.

The prediction image generator 509 receives the motion vector information and the reference image from the interpolation filter processor 508, uses the reference image to perform motion compensation prediction of sub-pixel precision based on the motion vector information, and generates a prediction image signal based on the prediction mode information.

The decoding controller 510 controls the entire decoding apparatus 500. For example, the decoding controller 510 controls the amount of accumulation of the reproduction image signal in the frame memory 506, and controls the interpolation filter coefficients of the interpolation filter processor 508.

According to the sixth embodiment explained above, the encoded data subjected to the filter processing by the video encoding apparatus according to the fifth embodiment can be decoded, and the encoding efficiency can be enhanced synergistically using the combination of the loop filter processor including the adaptive image decoding filter and the interpolation filter processor of high precision for directly obtaining the pixel value at the sub-pixel position from the integer-pixels.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video encoding apparatus comprising:
a controller configured to generate a loop filter information item indicating information for performing filter processing on a local decoded image signal;
a loop filter processor configured to perform the filter processing on the local decoded image signal based on the loop filter information item to generate a reproduction image signal;
a interpolation filter processor configured, if motion compensation prediction of quarter pixel precision is performed, to directly calculate a sub-pixel value of the sub-pixel displaced from an integer-pixel by a quarter pixel in one of a horizontal direction and a vertical direction, based on integer-pixel values of the reproduction image signal, and to generate a reference image including a integer-pixel and a sub-pixel;
a generator configured to generate a prediction image signal representing a prediction image by performing motion compensation prediction on the reference image;
a transform unit configured to transform a residual signal to obtain a transform coefficient information item, the residual signal indicating a difference between the prediction image signal and an input image signal which is an image signal that has been input, the transform coefficient information item indicating a frequency component value of the pixel;
a quantizer configured to quantize the transform coefficient information item to obtain quantized transform coefficient information item; and
an encoder configured to encode the quantized transform coefficient information item and the loop filter information item.

2. The apparatus according to claim 1, wherein if a first sub-pixel value of a first sub-pixel between a first integer-pixel and a second integer-pixel adjacent to the first integer-pixel is calculated, the interpolation filter processor calculates a first value by adding all values obtained by multiplying first integer-pixel values with an interpolation filter coefficient corresponding to the integer-pixel having the first integer-pixel values, the first integer-pixel values being pixel values of integer-pixels in one of a row and a column to which the first sub-pixel belongs, calculates a second value obtained by adding an adjustment value indicating a value for adjusting round-off for bit shift operation to the first value, and calculates the first sub-pixel value by performing bit shift operation on the second value in accordance with the number of bits represented by a shift number.

3. The apparatus according to claim 2, wherein the interpolation filter processor sets the interpolation filter coefficients to {−3, 12, −37, 229, 71, −21, 6, −1} if one of a second sub-pixel value of a sub-pixel displaced from a reference integer-pixel to right by the quarter pixel and a third sub-pixel value of a sub-pixel displaced from the reference integer-pixel to a lower side by the quarter pixel is calculated, sets the interpolation filter coefficients to {−1, 6, −21, 71, 229, −37, 12, −3} if one of a fourth sub-pixel value of a sub-pixel displaced from the reference integer-pixel to right by a three-quarter pixel and a fifth sub-pixel value of a sub-pixel displaced from the reference integer-pixel to the lower side by a three-quarter pixel is calculated, sets the adjustment value to 128 and sets the shift number to 8.

4. The apparatus according to claim 1, wherein the loop filter information item includes a filter coefficient information item, a filter application information item and a filter designation information item, the filter coefficient information item indicating information about a filter coefficient set for performing the filter processing, the filter application information item indicating information for determining whether or not a filter is applied, the filter designation information item indicating information for designating an applied filter among a plurality of filters, the loop filter processor further comprises:
a first switch configured to determine whether or not filter processing is performed based on the filter application information item;
a second switch configured to determine a filter to be applied based on the filter designation information item if the filter processing is performed; and
one or more filters configured to perform the filter processing based on the filter coefficient information item if the filter processing is performed, the loop filter processor performs the filter processing on filter processing target pixels using only integer-pixels included in a circle, by referring to an index corresponding to a radius of the circle and being included in the filter designation information item, the filter processing target pixels indicating integer-pixels to be subjected to the filter processing, the circle representing a pixel region which is used for the filter processing.

5. A video decoding apparatus comprising:
a decoder configured to decode, from encoded data, loop filter information item and quantized transform coefficient information item, the loop filter information item indicating information for performing filter processing on a decoded image signal, the decoded image signal indicating a signal of an image decoded with respect to a pixel, the quantized transform coefficient information item indicating a frequency component value of a pixel generated by transforming and quantizing a residual signal;
an inverse quantizer configured to inverse quantize the quantized transform coefficient information item to generate a reproduction transform coefficient information item;
an inverse transform unit configured to inverse transform the reproduction transform coefficient information item to generate a reproduction residual signal;
a interpolation filter processor configured, if motion compensation prediction of quarter pixel precision is performed, to directly calculate a sub-pixel value of a sub-pixel displaced from an integer-pixel by a quarter pixel in one of a horizontal direction and a vertical direction, based on integer-pixel values of the reproduction residual signal, and to generate a reference image including a integer-pixel and a sub-pixel;
a generator configured to generate a prediction image signal representing a prediction image by performing motion compensation prediction on the reference image; and
a loop filter processor configured to perform the filter processing on a decoded image signal based on the loop filter information item, the decoded image signal indicating the image signal which is added the reproduction residual signal and the prediction image signal and is decoded a pixel.

6. The apparatus according to claim 5, wherein if a first sub-pixel value of a first sub-pixel between a first integer-pixel and a second integer-pixel adjacent to the first integer-pixel is calculated, the interpolation filter processor calculates a first value by adding all values obtained, by multiplying first integer-pixel values with an interpolation filter coefficient corresponding to the integer-pixel having the first integer-pixel values, the first integer-pixel values being pixel values of integer-pixels in one a row and a column to which the first sub-pixel belongs, calculates a second value obtained by adding an adjustment value indicating a value for adjusting round-off for bit shift operation to the first value, and calculates the first sub-pixel value by performing bit shift operation on the second value in accordance with the number of bits represented by a shift number.

7. The apparatus according to claim 6, wherein the interpolation filter processor sets the interpolation filter coefficients to (−3, 12, −37, 229, 71, −21, 6, −1) if one of a second sub-pixel value of a sub-pixel displaced from a reference integer-pixel to right by the quarter pixel and a third sub-pixel value of a sub-pixel displaced from the reference integer-pixel to a lower side by the quarter pixel is calculated, sets the interpolation filter coefficients to {−1, 6, −21, 71, 229, −37, 12, −3} if one of a fourth sub-pixel value of a sub-pixel displaced from the reference integer-pixel to right by a three-quarter pixel and a fifth sub-pixel value of a sub-pixel displaced from the reference integer-pixel to the lower side by a three-quarter pixel is calculated, sets the adjustment value to 128 and sets the shift number to 8.

8. The apparatus according to claim 5, wherein the loop filter information item includes a filter coefficient information item, a filter application information item and a filter designation information item, the filter coefficient information item indicating information about a filter coefficient set for performing the filter processing, the filter application information item indicating information for determining whether or not a filter is applied, the filter designation information item indicating information for designating an applied filter among a plurality of filters,
the loop filter processor further comprises:
a first switch configured to determine whether or not filter processing is performed based on the filter application information item;
a second switch configured to determine a filter to be applied based on the filter designation information item if the filter processing is performed; and
one or more filters configured to perform the filter processing based on the filter coefficient information item if the filter processing is performed, the loop filter processor performs the filter processing on filter processing target pixels using only integer-pixels included in a circle, by referring to an index corresponding to a radius of the circle and being included in the filter designation information item, the filter processing target pixels indicating integer-pixels to be subjected to the filter processing, the circle representing a pixel region which is used for the filter processing.

9. A video encoding method comprising:
generating a loop filter information item indicating information for performing filter processing on a local decoded image signal;
performing the filter processing on the local decoded image signal based on the loop filter information item to generate a reproduction image signal;
calculating directly a sub-pixel value of a sub-pixel displaced from an integer-pixel by a quarter pixel in one of a horizontal direction and a vertical direction, based on integer-pixel values of the reproduction image signal if motion compensation prediction of quarter pixel precision is performed, and generating a reference image including a integer-pixel and a sub-pixel;
generating a prediction image signal representing a prediction image by performing motion compensation prediction on the reference image;
transforming a residual signal to obtain a transform coefficient information item, the residual signal indicating a difference between the prediction image signal and an input image signal which is an image signal that has been input, the transform coefficient information item indicating a frequency component value of the pixel;
quantizing the transform coefficient information item to obtain quantized transform coefficient information item; and
encoding the quantized transform coefficient information item and the loop filter information item.

10. The method according to claim 9, wherein if a first sub-pixel value of a first sub-pixel between a first integer-pixel and a second integer-pixel adjacent to the first integer-pixel is calculated, the directly calculating the sub-pixel value calculates a first value by adding all values obtained by multiplying first integer-pixel values with an interpolation filter coefficient corresponding to the integer-pixel having the first integer-pixel values, the first integer-pixel values being pixel values of integer-pixels in one of a row and a column to which the first sub-pixel belongs, calculates a second value obtained by adding an adjustment value indicating a value for adjusting round-off for bit shift operation to the first value, and calculates the first sub-pixel value by performing bit shift operation on the second value in accordance with the number of bits represented by a shift number.

11. The method according to claim 10, wherein the directly calculating the sub-pixel value sets the interpolation filter coefficients to {−3, 12, −37, 229, 71, −21, 6, −1} if one of a second sub-pixel value of a sub-pixel displaced from a reference integer-pixel to right by the quarter pixel and a third sub-pixel value of a sub-pixel displaced from the reference integer-pixel to a lower side by the quarter pixel is calculated, sets the interpolation filter coefficients to (−1, 6, −21, 71, 229, −37, 12, −3) if one of a fourth sub-pixel value of a sub-pixel displaced from the reference integer-pixel to right by a three-quarter pixel and a fifth sub-pixel value of a sub-pixel displaced from the reference integer-pixel to the lower side by a three-quarter pixel is calculated, sets the adjustment value to 128 and sets the shift number to 8.

12. The method according to claim 9, wherein the loop filter information item includes a filter coefficient information item, a filter application information item and a filter designation information item, the filter coefficient information item indicating information about a filter coefficient set for performing the filter processing, the filter application information item indicating information for determining whether or not a filter is applied, the filter designation information item indicating information for designating an applied filter among a plurality of filters, the performing the filter processing further comprises:
determining whether or not filter processing is performed based on the filter application information item;
determining a filter to be applied based on the filter designation information item if the filter processing is performed; and
performing the filter processing based on the filter coefficient information item if the filter processing is performed, the performing the filter processing performs the filter processing on filter processing target pixels using only integer-pixels included in a circle, by referring to an index corresponding to a radius of the circle and being included in the filter designation information item, the filter processing target pixels indicating integer-pixels to be subjected to the filter processing, the circle representing a pixel region which is used for the filter processing.
